(19) United States
(12) Patent Application Publication
(10) Pub. No.: US 2006/0088806 A1
(43) Pub. Date: Apr. 27, 2006

(54) Learning integrating system and methods

(76) Inventor: Clark Quinn, Walnut Creek, CA (US)

Correspondence Address: Clark Quinn, PhD, 60 Cuesta Way, Walnut Creek, CA, 94597, US

(21) Appl. No.: 10/973,756

(22) Filed: Oct. 26, 2004

(51) Int. Cl. H04M 3/51; G09B 19/00

(52) U.S. Cl. 434/236; 434/219; 705/11

(57) ABSTRACT

Aspects of the invention enable one or more persons to be provided with effective and relevant education, training, coaching or other learning in a manner that can be integrated with their personal, business or other ordinary activities. Aspects further enable contouring of the learning to better meet a person's specific needs and providing of assistance to the person as he attempts to utilize what he has learned. An embodiment of the invention provides activity descriptors within existing scheduling, todo, communication or other locally or remotely executable ordinary activity system that users may otherwise use to conduct personal, business or other ordinary activities. A user initiating, scheduling or selecting an ordinary activity and selecting an activity descriptor may schedule or initiate providing of learning activities. The learning activities, which may be provided via a course model including anchored or non-anchored course sessions, may then be provided according to user-goal or evaluation determinable levels, and/or according to one or more of opportunistic, deterministic and/or other learning approaches. The learning may also include providing to the user one or more of preparatory education content, prompting education content for assisting the user in conducting the activity or activities, user preparedness and/or completion performance evaluation and/or other learning.

### BACKGROUND OF THE INVENTION

1. Field of the Invention

This invention relates generally to computer systems, and more particularly provides a system and methods for integrating user learning with activities otherwise conducted by users.

2. Description of the Background Art

Learning can provide an invaluable asset in expanding our knowledge and experience both personally and professionally. However, participating in learning can be problematic.

Traditional education, for example, provides broad training in many subjects. However, institutional learning can be expensive—particularly at post-secondary levels. It also requires students to travel to a campus, leaving behind their home or office and the very real-life issues that their learning may help to enrich. Traditional education is also directed at preparing generic students for general testing in general subjects using generic materials, lasts for a limited time and then ends. Home study options avoid the travel of institutional learning. However, most problems of institutional learning still remain, and without the assistance otherwise provided.

Recently, personal computing software manufacturers have begun to provide aspects of more traditional education. Particularly promising is the ability of computing to provide users with a standardized interface, integral network access and multimedia presentation capabilities. Unfortunately, resulting programs tend to mimic their manual counterparts, thereby incorporating problems of traditional education to those of conventional computing in general.

Current education software generally falls into two categories, including single-user self-study programs (e.g., books, game-like environments and so-called tutors), and so-called remote education or remote “learning”. Single user applications, like traditional education, only apply to general topics and generalized students. They also similarly force users to interrupt their other work, other software programs, real-life and real-life issues and activities to instead resolve hypothetical and often irrelevant problems. The programs, which mimic earlier business counterparts, also address only generalized needs in general ways that do not relate well to a user's real-life needs and then end.

Current remote education programs essentially port prior video conferencing or on-demand delivery of recordings to generalized education. Among other problems, video conferencing merely provides a classroom image to the student, while on-demand delivery provides only generically directed content, and both bring with them problems of traditional education.

Current educational programs also tie the student to the personal computer (PC) or laptop as with other conventional software. Thus, in many instances, it would be impractical at best for a student having a free moment to conduct his education. Worse yet, each conventional computer program tends to performs a distinct generic and un-assisting function for general use that, like traditional education, users start, use in an isolated manner and then end, leaving the student without further support.

Accordingly, there is a need for systems and methods that enable a person seeking to further his education to integrate his learning with his personal, business or other real-life activities. There is also a need for systems and methods that enable contouring of learning to better meet the person's specific needs, or to provide assistance to a person in utilizing what he has learned.

### SUMMARY OF THE INVENTION

Aspects of the invention enable one or more persons to be provided with education, training, coaching or other learning in a manner that may be integrated with and contextually adapted to their personal, business or other real-life activities. Aspects further enable contouring of the learning to better meet a person's (or “student's”) specific scheduling, content, relevance, availability or other learning needs, and assisting a student in applying what he has learned.

Various embodiments of the invention provide for integrating learning (or “education”) activities with “ordinary” activities ordinarily conducted, tracked or otherwise processed by a user activity system without regard to providing learning as taught herein. One embodiment provides for causing initiating, scheduling, selecting, modifying or other processing of at least one ordinary activity to initiate, schedule, select, modify, associate or otherwise manipulate one or more learning activities. Another embodiment provides for determining at least one available ordinary activity for use as a learning opportunity according to which corresponding education content or scheduling may be determined or anchored, and which may itself be used as a learning example or assisted via more deterministic, opportunistic and/or other learning approaches. Another embodiment provides for integrating at least one education activity indicator with an ordinary activity indicator of an ordinary activity otherwise documented using scheduling, todo, conferencing, communication, project/contact management or other locally/remotely executable ordinary activity code for conducting personal, business or other ordinary activities. Other embodiments provide for determining a suitable level of learning corresponding to a user, ordinary activity, desired completion date or other parameters. Various embodiments still further provide for learning to be conducted automatically or with user intervention that may override automatic education system operation.

Learning that may be provided to a user may, for example, include one or more of: preparatory learning activities, learning content presented to a user during an ordinary activity, and post ordinary activity learning. Learning may also, for example, include coaching, prompting and evaluating. (Coaching is typically provided prior to an ordinary activity, prompting is typically provided during an ordinary activity and evaluating is typically provided before or after an ordinary activity. The present invention, however, enables these and/or other learning/content providing to be customized.) Current and/or prior learning may further affect the level, content, scheduling, progress or other aspect(s) of one or more of further learning/content.

A learning integration system embodiment according to the invention includes an education integrator for determining ordinary activity system processing of one or more ordinary activities, and an education manager for determining and scheduling or initiating presenting of one or more learning activities corresponding in time, type, user goal and/or content to one or more of the ordinary activities. The learning integration system embodiment may further comprise a learning model including education parameters and education content used by the education manager to determine and schedule and/or present the learning activities. The learning model may further comprise one or more education courses in which a course may include one or more education sessions and an education session may include one or more education activities; one or more of the courses, sessions and education activities may further correspond to one or more different education levels.

Where, for example, activity code of an ordinary activity system monitors or implements scheduled business, personal or other life (ordinary) activities of a user, the education integrator may respond to an activity event indicating a scheduled or tracked or otherwise “processed”) ordinary activity by initiating the education manager to schedule or provide to the user one or more evaluating or preparing education sessions relating to and in advance of the ordinary activity, to provide prompting assistance to the user in conjunction with an occurrence of the ordinary activity or to provide evaluation or other learning. Where the activity monitors successive related activities, the activity integrator may initiate the education manager to provide such education in advance of or in conjunction with one or more of the activities, for example, according to one or more of a deterministic, opportunistic or other learning approach, and so on.

Another learning integration system embodiment according to the invention includes learning code integrated with or monitoring an activity system that processes one or more ordinary activities. The learning code includes an education integrator for determining ordinary activity processing by the ordinary activity system and an education manager for processing learning activities to correspond with the determined ordinary activity processing (i.e., or absence thereof). The education manager includes, preferably within a learning model, one or more anchored or non-anchored education activities and education parameters including education scheduling parameters and education content.

The learning manager also includes an education scheduler that is configurable for opportunistically or deterministically scheduling the anchored or non-anchored education activities at a time corresponding to the presence or absence of ordinary activities and/or using an ordinary activity as a learning example. A learning integration method embodiment according to the invention includes determining processing of one or more ordinary activities by an ordinary activity system, determining at least one education activity corresponding to at least one of the ordinary activities, and scheduling presenting of the education activity on a due date corresponding to a due date of the ordinary activity.

Another learning integration method embodiment according to the invention includes determining that an education activity is to be conducted within a presentation period, determining whether an ordinary activity of a user is available, has a type that corresponds to the education activity and has a due date that corresponds to the presentation period of the education activity, and if so, then scheduling presenting of the education activity to correspond with the due date of the ordinary activity. The method may also provide, if such an ordinary activity is unavailable, for creating a faux ordinary activity (faux activity) having a due date within the presentation period and scheduling the education activity to correspond with the due date of the faux activity. The education activity may further be included in an education session having at least one other education activity, the method further including scheduling presenting of the other education activity of the education session to correspond with presenting of the education activity. The method may also include associating the education activity with the ordinary or faux activity, and responding to a modification of the ordinary or faux activity by determining a corresponding modification of the education activity.

A further learning method embodiment according to the invention includes determining that an ordinary activity for which learning is desired by a user is to be conducted on a due date, determining one or more education activities that correspond the ordinary activity and scheduling the education activities to be presented on or before the due date. In another embodiment, corresponding education activities include activities having different levels, and the method includes determining education activities having levels such that the education activities may be presented on or before the due date.

Yet another learning method embodiment according to the invention includes receiving, from an ordinary activity system corresponding to at least one user, an indicator indicating processing of an ordinary activity, receiving from the ordinary activity system an activity type indicator indicating an activity type, determining at least one education activity corresponding to the ordinary activity, and associating the education activity with the ordinary activity by embedding an education activity indicator within the ordinary activity system. The education activity indicator may further include a user interface element for indicating the associating to the user, or further, for enabling user modification of the education activity by manipulating the user interface element via the ordinary activity system.

A still further learning method embodiment according to the invention includes receiving, from an ordinary activity system corresponding to at least one user, an indicator indicating processing of an ordinary activity, receiving from the ordinary activity system an activity type indicator indicating an activity type, and associating with the ordinary activity at least one education activity providing coaching corresponding to the ordinary activity, prompting that facilitates conducting of the ordinary activity and evaluating that evaluates at least one of a user's preparedness for conducting the ordinary activity and a user's conducting of the ordinary activity. Various other embodiments further provide for scheduling presenting of the coaching prior to or within a predetermined time period before conducting the ordinary activity, scheduling presenting of the prompting concurrently with the ordinary activity, scheduling presenting of the evaluating a user's preparedness prior to the ordinary activity and/or scheduling presenting of the evaluating a user's conducting of the activity following or within a predetermined time period following conducting of the ordinary activity.

A further learning integration method embodiment according to the invention includes adding, to activity code for processing ordinary activities, one or more predetermined activity type indicators for indicating an activity type corresponding to an ordinary activity, responding to a use selection of an activity specifier by determining scheduling of the ordinary activity and scheduling at least one presenting of the coaching prior to or within a predetermined time period before conducting the ordinary activity, presenting of the prompting concurrently with the ordinary activity, presenting of the evaluating a user's preparedness prior to the ordinary activity and/or presenting of the evaluating a user's conducting of the activity following or within a predetermined time period following conducting of the ordinary activity.

Another learning integration system embodiment according to the invention includes providing computer code for causing a computer to perform the steps of receiving a user indication of an activity event type of an activity for which education is applicable, determining scheduling of the ordinary activity and scheduling at least one presenting of the coaching prior to or within a predetermined time period before conducting the ordinary activity, presenting of the prompting concurrently with the ordinary activity, presenting of the evaluating a user's preparedness prior to the ordinary activity and/or presenting of the evaluating a user's conducting of the activity following or within a predetermined time period following conducting of the ordinary activity.

Advantageously, aspects of the invention enable a user to conduct his business, personal or other life activities in a substantially normal manner using activity scheduling or implementing software while, concurrently (or thereafter) causing relevant user education to be initiated. Aspects also enable the education to be provided using only little resources or in a distributed manner, such that a user's education can also be conducted via a user's cell phone, PDA, PC and/or essentially any other devices. Among other aspects, a user's education can be conducted in conjunction with a wide variety of locally or mobally executable activity code, such as calendaring, contact management, communications, online purchasing and todo lists, to name just a few. Other advantages will also become apparent by reference to the following text and figures.

### BRIEF DESCRIPTION OF THE DRAWINGS

FIG. 1a is a flow diagram illustrating an education integration system according to an embodiment of the invention;

FIG. 1b is a flow diagram illustrating various education integration system configurations according to an embodiment of the invention;

FIG. 2 is a block diagram illustrating a computer system in accordance with an embodiment of the invention;

FIG. 3a is a flow diagram illustrating an education integration system according to an embodiment of the invention;

FIG. 3B is a flow diagram illustrating an education model, according to an embodiment of the invention;

FIG. 4a is a block diagram illustrating an application program interface (“API”) of FIG. 3 in greater detail, according to an embodiment of the invention;

FIG. 4b is a block diagram illustrating a planner of FIG. 3 in greater detail, according to an embodiment of the invention;

FIG. 4c is a flow diagram illustrating operation of API components of FIG. 4A in greater detail, according to an embodiment of the invention;

FIG. 5a is a flow diagram illustrating generating of activity events, according to an embodiment of the invention;

FIG. 5b is a flow diagram illustrating scheduling of one or more education sessions in conjunction with an education system receiving activity events according to an embodiment of the invention;

FIG. 5c is a flow diagram illustrating scheduling of one or more education session levels in conjunction with an education system receiving activity events according to an embodiment of the invention;

FIG. 6a1 illustrates an example of a user interface embedded within an activity system according to an embodiment of the invention;

FIG. 6a2 illustrates an example of an education topic selecting interface according to an embodiment of the invention;

FIG. 6a3 illustrates an example of an activity or goal descriptor selecting interface according to an embodiment of the invention;

FIG. 6a4 illustrates an example of an education planning or scheduling interface according to an embodiment of the invention;

FIG. 6a5 illustrates an example of an education level selecting interface according to an embodiment of the invention;

FIG. 6a6 illustrates an example of an education integration system preference selecting interface according to an embodiment of the invention;

FIG. 6b illustrates an example of education session embedding within an activity system according to an embodiment of the invention;

FIG. 7a illustrates an example of embedding of one or more education sessions within a corresponding activity system according to an embodiment of the invention;

FIG. 7b illustrates a further example of embedding of one or more education sessions within a corresponding activity system according to an embodiment of the invention;

FIG. 8a is a flow diagram illustrating an example of an education content or scheduling information configuration according to an embodiment of the invention;

FIG. 8b is a flow diagram illustrating a further example of an education content or scheduling information configuration according to an embodiment of the invention;

FIG. 9 illustrates an example of education sessions according to an embodiment of the invention;

FIG. 10 is a flowchart illustrating an education integration method according to an embodiment of the invention;

FIG. 11 is a flowchart illustrating step 1007 of FIG. 10 in greater detail, according to an embodiment of the invention;

FIG. 12 is a flowchart illustrating step 1109 of FIG. 11 in greater detail, according to an embodiment of the invention;

FIG. 13 is a flowchart illustrating a method for determining scheduling of one or more integrated education sessions employing at least one anchor activity, according to an embodiment of the invention;

FIG. 14 is a flowchart illustrating a method for determining scheduling of one or more integrated education sessions employing at least one anchor activity in conjunction with a modification of a corresponding activity schedule, according to an embodiment of the invention; and

FIG. 15 is a flowchart illustrating a method for determining scheduling of one or more integrated education sessions employing determinative education session scheduling, according to an embodiment of the invention.

### DETAILED DESCRIPTION

In providing for education integration system and methods, aspects of the invention enable one or more persons to be provided with one or more of education, training, coaching, prompting, evaluating or substantially any other learning. Aspects further enable such learning to be integrated with personal, business or other ordinary activities otherwise conducted by a user or users. Aspects also enable learning to be contoured to a person's or persons' available time, location, available devices, existing education level, knowledge expanding, performance support or other needs/goals. Aspects further enable learning to be integrated with a wide variety of ordinary activities that are otherwise monitored, scheduled, conducted or otherwise implemented via one or more local or remotely located computing systems otherwise used for conducting ordinary activities.

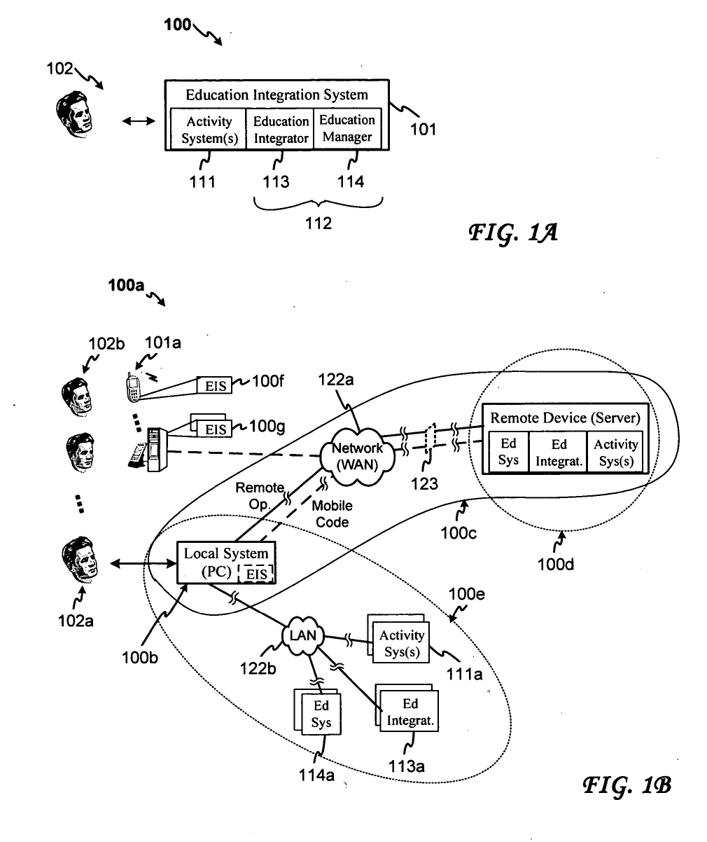

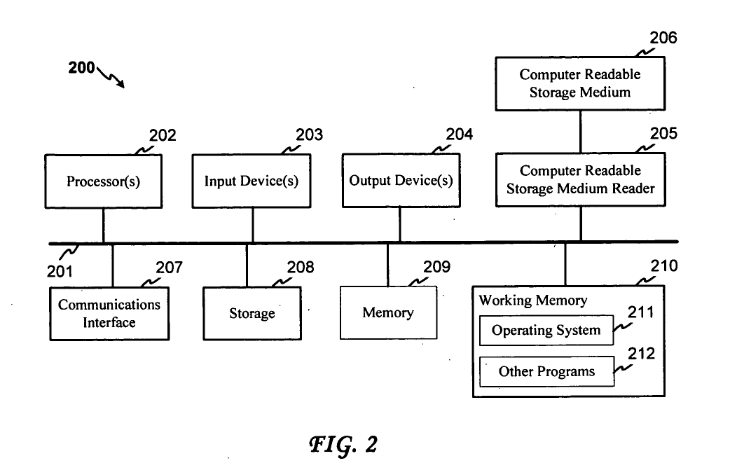

FIGS. 1A and 1B illustrate learning integration system examples that are selected in order to provide a better understanding of the invention. Other examples will also become apparent to those skilled in the art in view of the discussion herein. (Note that the term “or”, as used herein, is intended to generally mean “and/or”, unless otherwise indicated. “Learning” and “education” are also used in an interchangeable manner with reference to a any or all potential or actual mechanisms for effectuating cognitive development.)

FIG. 1A illustrates a learning integration system 100 example that is operable by at least one user 102 in conjunction with at least one corresponding ordinary activity system 111 (activity system) running on at least one user operable or “user” device 101. Learning integration system 100 includes learning system 111 and activity system 114.

User device 101 provides a host computing system for hosting learning integration system elements, and can include essentially any computing system or cooperating such system capable of hosting (in whole or part) at least one activity system and at least initiating learning integration system elements not inconsistent with the description herein, or of providing a user interface for one or more other devices hosting one or more activity systems and such education systems in whole or part.

Suitable activity systems of varying types to which integrated education can be conducted by one or more integrated learning systems as taught herein, while not otherwise considered as such, are already conducted on many computing systems. Integrated education system 112. Many activity systems also require little processing or storage resources, can be readily distributed in whole or part using locally or mobally executable code, and can be readily operate or be converted for operation on various user devices using readily available compilers, converting, synchronization or other mechanisms, many of which are well known. User devices may therefore include but are not limited to fixed-location or portable computing systems such as personal computers/servers, cell phones, personal data assistants or “PDAs” (including personal information managers or “PIMs”), game systems, settop boxes, cell phones, and so on.

Activity system 111 includes computer code that can be used by one or more users to schedule, monitor, conduct or otherwise process one or more ordinary activity events of one or more ordinary activities. Such activity code can, for example, include one or more of application programs, add-ons, mobile code, and so on, in whole or part.

Activity system 111 preferably operates as a host application to which at least one learning integration system can be added, or can alternatively operate as an indicator of events corresponding to user activities, which events are determinable by a suitable education integrator. (As will be discussed, determining can be accomplished, for example, by at least one of learning integration system monitoring of the user system or activity system operation/event generation, or by an learning integration system receiving from the user system or activity system an indicator indicating an activity processing or event.) An activity event includes an indicator of an activity processing that can correspond to a user or application code selecting, scheduling, initiating, modifying, conducting or otherwise processing one or more ordinary activities or portions thereof.

Examples of suitable activity systems can include but are not limited to one or more of appointment, contact, project or so-called Todo List management software, scanning programs, communications software (e.g., email, phone, conference, contact, etc.), synchronization software, browser code such as for conducting browsing of an Internet Web site or computer, an online purchase or selecting of an education Tag (which Tag type may be implemented in accordance with the teachings herein), and so on, so long as integrated learning not inconsistent with the teachings herein can be caused to correspond thereto.

Integrated learning system (hereinafter “learning system”) 112 includes learning code that is capable of responding to activity events of activity system 112 by presenting to a user learning media or otherwise providing user learning. Learning system 112 includes education integrator 113 and education manager 114. (Note that the terms “education” and “learning” will be used interchangeably herein for convenient naming of learning system elements.)

Education integrator 113 provides for determining the occurrence of activity events of ordinary activities and for initiating education system operation in conjunction with such (ordinary) activity events. Education integrator 113 may further provide for communication with a corresponding activity system or external systems such as 100d, 111a, 113a, 114a, and so on. Servers, personal computers or other external systems external to a learning integration system can, for example, provide activity parameters or other information to an integrated education system such that education information appears as or is presented in conjunction with activity information of an activity system. Such systems may also provide for loading or up/down loading of education content, parameters or other activity/education information. Such determining may include monitoring an ordinary activity system, receiving an activity event indicator from an ordinary activity system, and so on, via direct or indirect wired/wireless coupling, such as via one or more of networks, operating systems, event/code linking (e.g., an application program interface or API, data linking, SOAP or other inter or intra device messaging, mobile code, etc.), and so on. Such determining may also occur in conjunction with user selection or automatically (i.e., programmatically), such as in conjunction with the occurrence of a timed or event-driven activity event implemented by activity system 111 irrespective of learning system operation.

Education manager 113 provides for responding to education integrator 112 initiation by causing learning content or parameters to be provided, scheduled, modified or presented to a user. Education manager 113 may further provide for receiving learning content, parameters or other learning information, such as from an activity, networked or other system, adding or integrating such information, or for providing such information to a user. Learning content may, for example, include but is not limited to user evaluation content, coaching content, prompting content, and so on, only some examples of which may be specifically discussed herein.

The FIG. 1B flow diagram illustrates further examples of how a learning integration system may also be implemented in a more distributed manner, for example, in conjunction with one or more statically or dynamically configurable networks. (Certain mechanisms that might also be used and many of which are well known, such as routers, gateways, backup systems and the like, are not shown so that the aspects of the invention might be better understood. It will be appreciated, however, that such devices may be used alone or in conjunction with integrated learning in an otherwise conventional manner or otherwise in accordance with the teachings herein.)

A user 102a may utilize one or more learning integration systems 100a-g alone or in conjunction with one another, which systems may be implemented within one device, distributed among more than one device or operate through one or more interfaces or other code provided by one or more of these or other intermediary devices. Such devices may be wired or wirelessly coupled, for example, using at least one of a wide area network (WAN) 122a, such as the internet, a telephone network or a cellular network, or via a local area network, such as a home network (e.g., 802.11x, Bluetooth, etc.), a private network, and so on, and may incorporate one or more firewalls (e.g., firewall 123) or other security or other intermediary mechanisms in an otherwise conventional manner.

System 100a may, for example, include a learning integration system or operate as a front end for a networked such system 100b-c that may be implemented, for example, using one or more of resident or mobally executable code, such as Java, ActiveX, and so on. Learning integration system components may also operate in conjunction with information servers that convert, otherwise modify or provide content, code or other activity/learning information for transfer to/from other (e.g., less capable) devices or that provide voice recognition/synthesis or other services to such devices, taking into account potentially limited memory, processing or other resources of such devices (e.g., cell phones, PDAs, and so on). Learning integration system components may be distributed within more than one device (e.g., 101d) operating in accordance with the teachings herein, but performing computing operations in an otherwise conventionally distributed manner. Multiple users may further utilize various user devices (e.g., 201e) to conduct or operate the same or more than one of learning integration systems or learning integration system instantiations in whole or part, for example, as might be provided by server 101c.

A user may, for example, conduct his appointments or other activities using one computing system (e.g., a PDA) in one instance and using another computing system (e.g., a PC) in another instance, using synchronization or other code to add/modify non-conflicting new ordinary activity information or resolve conflicting new ordinary activity information to one or both computing systems. A user ay also conduct different activities using different computing systems, the results of which may or may not be synchronized or otherwise shared among more than one device. Various security systems may also be used, among still other alternatives. Systems 102a-e do not require interfering with such synchronization, security or other systems, and are capable of integrating learning information with the ordianry activity or other system information (e.g., enabling conventional synchronization to synchronize both), or of providing separate learning information in such a form that can be synchronized or secured in substantially the same manner (e.g., as readily convertible or synchronize-able education, scheduling or content data). Among other examples, it is also common for multiple users to share a calendar, contacts, project information, and so on, or otherwise conduct ordinary activities in a shared manner. Here too, it will become apparent that systems 102a-e do not require interfering with handling/conducting multi-user activities, or may enable integrated learning to be conducted in a substantially similar manner requiring little or no activity system modification (e.g., see hooks and linking below).

Turning now to FIG. 2, an exemplary computing system is illustrated that may comprise one or more of the components of FIGS. 1A and 1B. While other alternatives might be utilized, it will be presumed for clarity sake that components of the systems of FIGS. 1A and 1B are implemented in hardware, software or some combination by one or more computing systems consistent therewith, unless otherwise indicated.

Computing system 200 comprises components coupled via one or more communication channels (e.g., bus 201) including one or more general or special purpose processors 202, such as a Pentium®, Centrino®, Power PC®, digital signal processor (“DSP”), and so on. System 200 components also include one or more input devices 203 (such as a mouse, keyboard, microphone, pen, and so on), and one or more output devices 204, such as a suitable display, speakers, actuators, and so on, in accordance with a particular application. (It will be appreciated that input or output devices can also similarly include more specialized devices or hardware/software device enhancements suitable for use by the mentally or physically challenged.)

System 200 also includes a computer readable storage media reader 205 coupled to a computer readable storage medium 206, such as a storage/memory device or hard or removable storage/memory media; such devices or media are further indicated separately as storage 208 and memory 209, which may include hard disk variants, floppy/compact disk variants, digital versatile disk (“DVD”) variants, smart cards, read only memory, random access memory, cache memory, and so on, in accordance with the requirements of a particular application. One or more suitable communication interfaces 207 may also be included, such as a modem, DSL, infrared, RF or other suitable transceiver, and so on for providing inter-device communication directly or via one or more suitable private or public networks or other components that may include but are not limited to those already discussed.

Working memory 210 further includes operating system (“OS”) 211 elements and other programs 212, such as one or more of application programs, mobile code, data, and so on for implementing system 100 components that might be stored or loaded therein during use. The particular OS or OSs may vary in accordance with a particular device, features or other aspects in accordance with a particular application (e.g. Windows, WindowsCE, Mac, Linux, Unix or Palm OS variants, a cell phone OS, a proprietary OS, Symbian, and so on). Various programming languages or other tools can also be utilized, such as those compatible with C variants (e.g., C++, C#), the Java 2 Platform, Enterprise Edition (“J2EE”) or other programming languages in accordance with the requirements of a particular application. Other programs 212 may further, for example, include one or more of activity systems, education managers, education integrators, or interface, security, other synchronization, other browser or groupware code, and so on, including but not limited to those discussed elsewhere herein.

When implemented in software (e.g. as an application program, object, agent, downloadable, servlet, and so on in whole or part), a learning integration system or other component may be communicated transitionally or more persistently from local or remote storage to memory (SRAM, cache memory, etc.) for execution, or another suitable mechanism can be utilized, and components may be implemented in compiled or interpretive form. Input, intermediate or resulting data or functional elements may further reside more transitionally or more persistently in a storage media, cache or other volatile or non-volatile memory, (e.g., storage device 208 or memory 209) in accordance with a particular application.

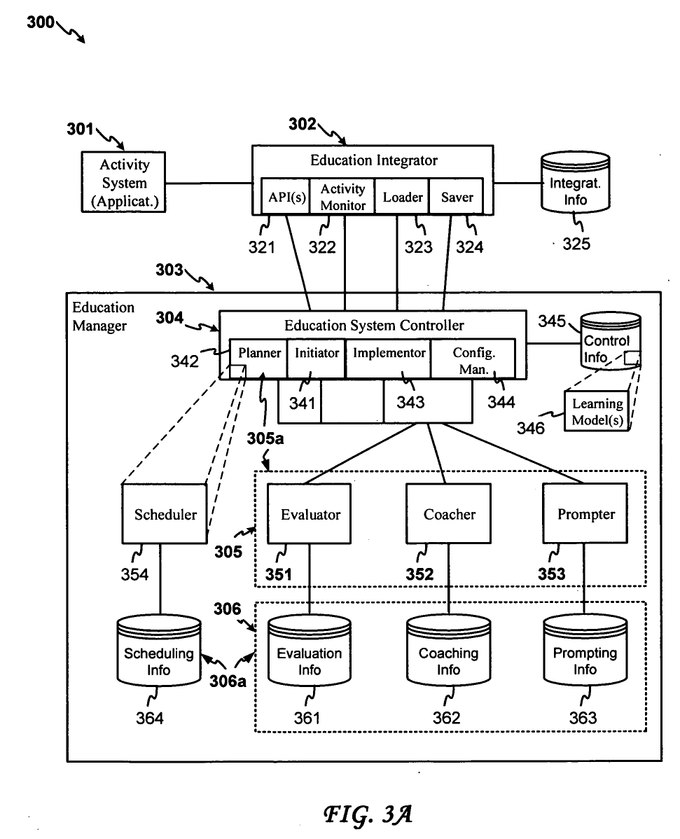

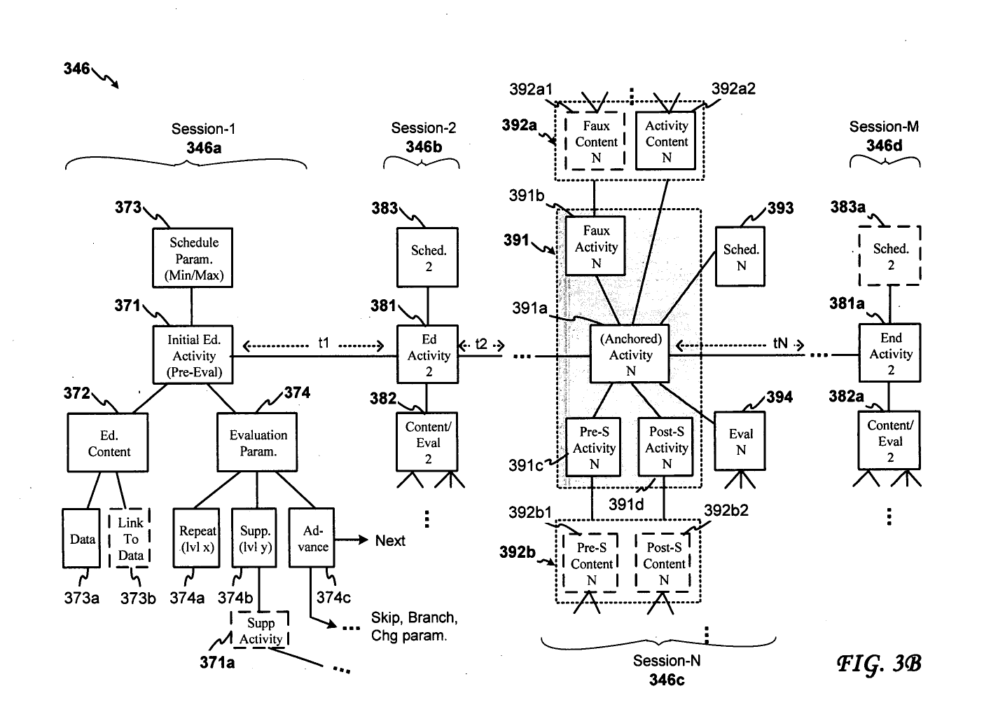

FIG. 3A illustrates an exemplary learning integration system 300 in greater detail. Learning integration system 300 includes ordinary activity system (activity system) 301, education integrator 302 and education manager 303, which components may, for example, correspond to one or more of similarly labeled components of FIGS. 1A and 1B.

Activity system 301 includes at least one application program or other program code (hereinafter, also “program”, “programs” or “software”) that provides for initiating, monitoring, scheduling, conducting or otherwise processing one or more ordinary activities. Microsoft Outlook, for example, may be viewed in the context of the present example as at least: an appointment or calendaring activity program or activity system that receives user appointment entry initiating and scheduling and then monitors but does not conduct user appointments; a contact activity application that enables users to initiate and monitor contact entries; and a communication (e.g., email, phone or conference) activity application that provides for initiating and conducting such communication activities, but provides little or no related scheduling or monitoring of such activities.

Other programs may also be alternatively viewed in the current context as providing for various aspects of the same or other ordinary activities for which integrated learning may be desirable, and may comprise suitable activity systems. For example, Todo programs may be viewed as including features that provide for monitoring of todo activities desirably completed at some point, or further (with some) as providing for scheduling, prioritizing, conducting or otherwise processing todo items. Project (management) programs can be viewed as including features providing for project activities in a similar manner as with calendaring. Conferencing programs may be viewed as including features for scheduling or conducting conferencing (ordinary) activities. Browser programs may be viewed as including features for conducting secure or unsecured Web surfing (ordinary) activities, purchasing (ordinary) activities, communication (ordinary) activities, and so on. Word processors and presentation programs may be viewed as including features for document creating or presenting (ordinary) activities, and so on. Users of one or more of these or other software may benefit from integrated learning aspects, such that even an exemplary list of suitable activity systems would be extensive when viewed in the context of the present invention.

Outlook or other activity programs or variants thereof are or soon will be available directly or via network connection on a wide variety of computer platforms, including but not limited to as PCs, cell phones, PDAs digital TVs, settop boxes, video game consoles and the like, which devices may comprise user devices for purposes of implementing learning integration. Such programs are implemented as one or more of applications, add-ons or other locally operable code, or mobally executable code (e.g., servelets, applets or other downloadables).

Activity systems running under Windows (X/CE), Apple Computer OSs, Palm OS, cell phone OSs, game/settop box OSs, or most other modern OSs also provide generic hooks for communicating application information via similar forms of an application program interface or “API”. This avoids prior proprietary or specially provided program hooks, adding new application hooks to existing code or adding OS/application operation tracking (which can also be used alone or in combination therewith). While such hooks have to date been used for more static business purposes (e.g., remote entering, listing appointments or adding menus, menu items or buttons for such operations), the present embodiment also exploits their inherent ability to enable monitoring of activity system operations or “events” that are instead received by an education integrator and used herein for providing one or more users with education.

Education integrator 302 provides for integrating within activity system 301 an ordinary-activity to learning or “integrated learning” interface through which implementing of user learning may be caused to correspond with ordinary use of activity system 301 (i.e., without the addition of learning system components 302 and 303). Education integrator 302 provides for conducting data transfer to and from activity system 301 or other external systems that might be used, for embedding and implementing a learning interface, for causing activity/education software to run, and for initiating scheduling or presenting of learning or ordinary activity information. The learning interface preferably includes an activity monitor for programmatically (hereinafter, “automatically”) initiating learning system response to predetermined (e.g., learning system/user selectable) ones of (ordinary) activity events occurring within activity system 301. The learning interface also preferably includes integrating within activity system 301 a user operable learning parameter selecting/initiating mechanism, including but not limited to one or more of menus, menu items, selection buttons, other suitable user interface mechanisms, and the like. (For clarity sake, learning events generated via operation of the learning interface will also be referred to as “education activity events”.)

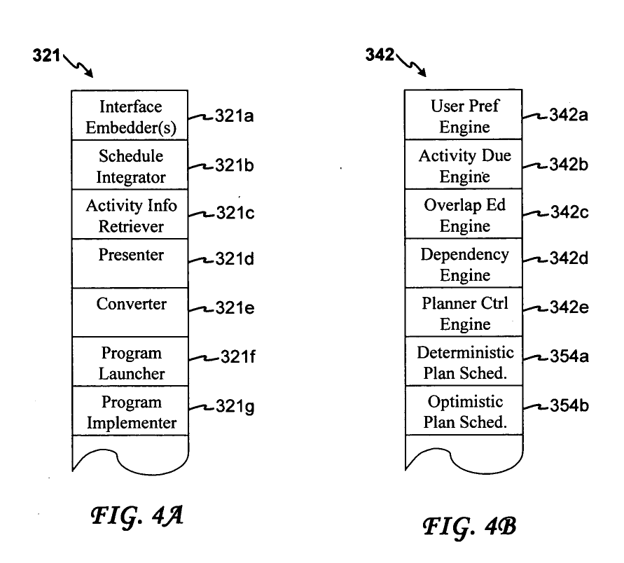

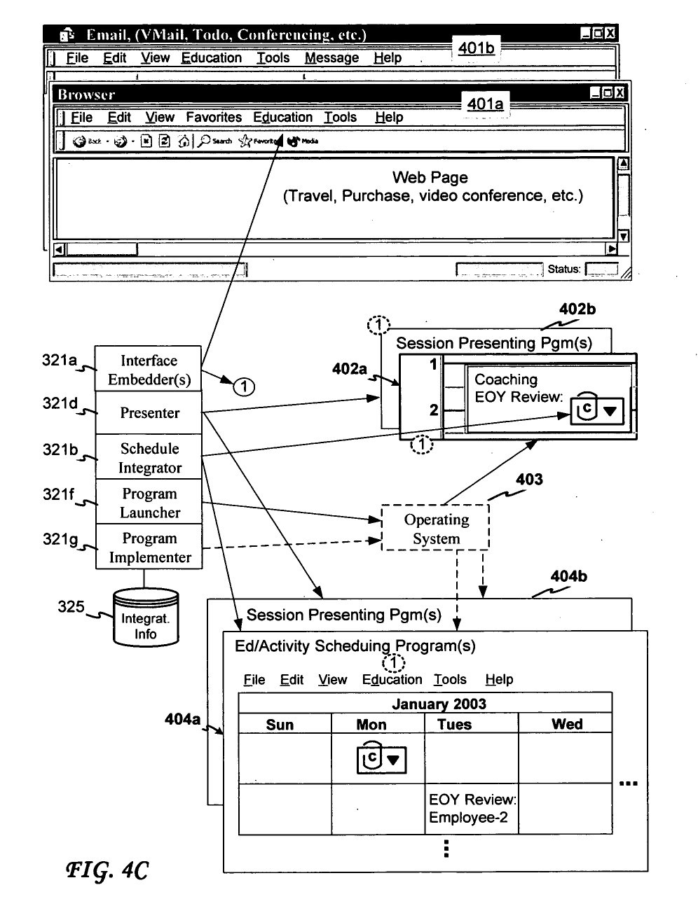

Within education integrator 302, one or more of APIs 321 may include otherwise conventionally implemented application program interfaces that instead provide for interfacing to one or more corresponding activity systems for providing a learning interface. APIs 321 further provide for transferring received ordinary activity events from the activity system to system monitor 322 and for causing activity system 301 to present learning information from system controller 304 or loader 323 to a user where the learning information is presented to the user via an activity system (e.g., see FIG. 4A). APIs 321 may also further provide one or more of learning scheduling or presenting code for presenting learning information directly to a user or via other code having corresponding features where, because an activity system is incapable or otherwise in accordance with a particular application, the learning information is not presented to the user via a corresponding activity system.

Among the remaining education integrator components, activity monitor 322 provides for determining one or more occurrences of ordinary/education activity events of activity system 301 and providing to education manager 303 activity event indicators indicating the activity events. (Activity events are preferably transferred to activity monitor 322 by APIs 321 or an OS implementing the activity system.)

Loader 323 provides for receiving from education manager 303 or an external system streaming, bulk, streaming or other multimedia education content, scheduling, activity system configuration, other parameters or other ordinary activity/learning information, which information loader 323 provides to APIs 321. (Multimedia, as used herein, refers to one or more media types, including but not limited to text, graphics, animation, audio, video and the like.) Loader 323 further provides for receiving content, parameters or other learning information from an external system (not shown) and transferring the learning information or to education manager 303. Saver 324 provides for receiving from APIs 321 learning information (e.g., user responses from an learning information presentation), which saver 323 provides to education manager 303 or an external system. Integration information storage 325 stores application information, such as active program indicators, APIs including API parameters, external system communication parameters, and the like for conducting learning integration.

(External systems, which are not shown in FIG. 3 for greater clarity, may, for example, include an education server (e.g., 100d of FIG. 1B) for providing learning content or learning or activity system/API updates, or that stores user responses, selections or statistics for further use.

Education manager 303 provides for conducting user learning corresponding to user use of activity system 301 either directly (e.g., via user operation of an activity system) or indirectly (e.g., via automatic activity system operation or automatic/user operation of an intermediary system, including but not limited to those discussed in FIG. 1B). Education manager 303 includes education system controller or “controller” 304, scheduler 354, teaching engines 305 including evaluator 351, coacher 352 and prompter 353, and education information storage including control information storage 345, scheduling information storage 364, evaluation information storage 361, coaching information storage 362 and prompting information storage 363. (Note that evaluator 351, coacher 352 and prompter 353 are also referred to in combination as “teaching engines” 305, and in further combination with planner 342 as “education engines” 305a.)

Education manager 303 is operable according to control parameters that direct controller 304 operation and at least one learning model 346. Learning model 346 defines scheduling, evaluation and presentation parameters according to which learning sessions (hereinafter “education sessions”) are planned and conducted by education engines 305a, and may further include learning content (education session content) that is presented to a user. The control parameters and learning model(s) may be initially loaded from an external system or control information storage 325, and are thereafter loaded to education manager components from control information storage 345 in conjunction with controller 304 initialization. (As is discussed elsewhere, computer code or data, including education session content or other learning information, may also be transferred, streamed or otherwise received from an external system, particularly though not necessarily in conjunction with less capable user devices.)

Controller 304 provides for control of education integrator 302 and education manager 303 component operation in conjunction with the implementing of integrated learning. For example, controller 304 receives ordinary/education activity events from activity system 301 via APIs 321 of education integrator 302. Controller 304 responds by initiating scheduler 354 for providing user selected or automatic scheduling of user education, or at least one of evaluator 351, coacher 352 or prompter 353 for respectively providing to one or more users, user evaluation, coaching or prompting.

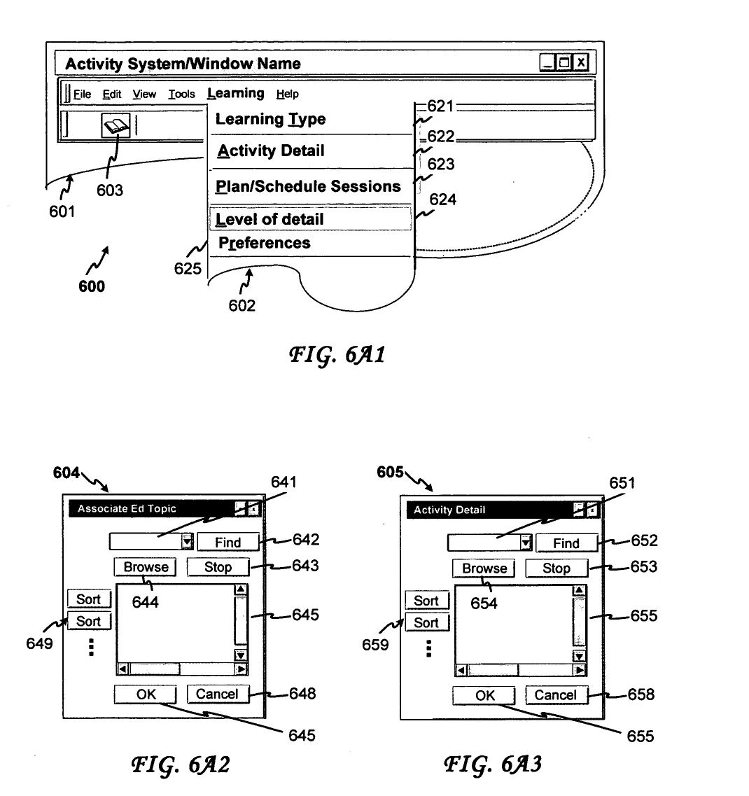

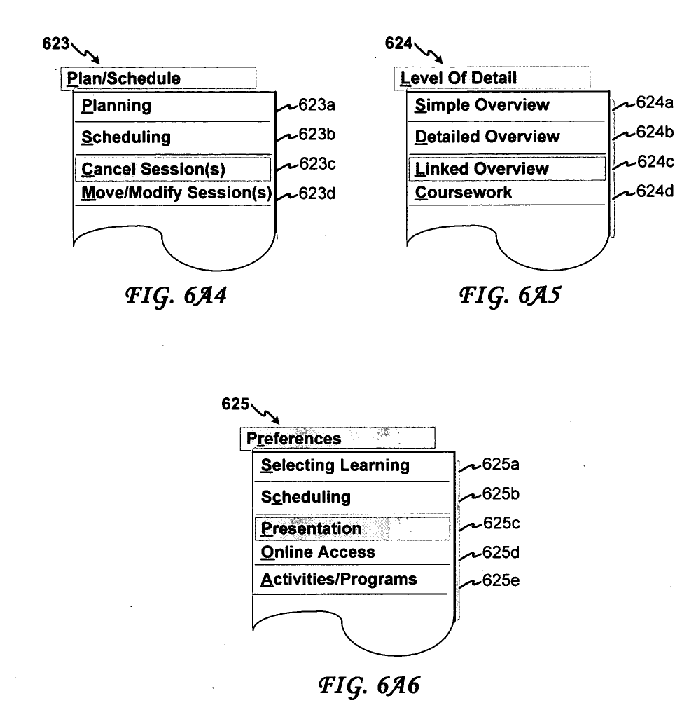

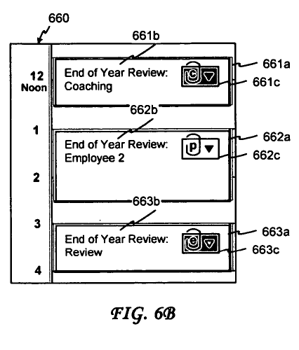

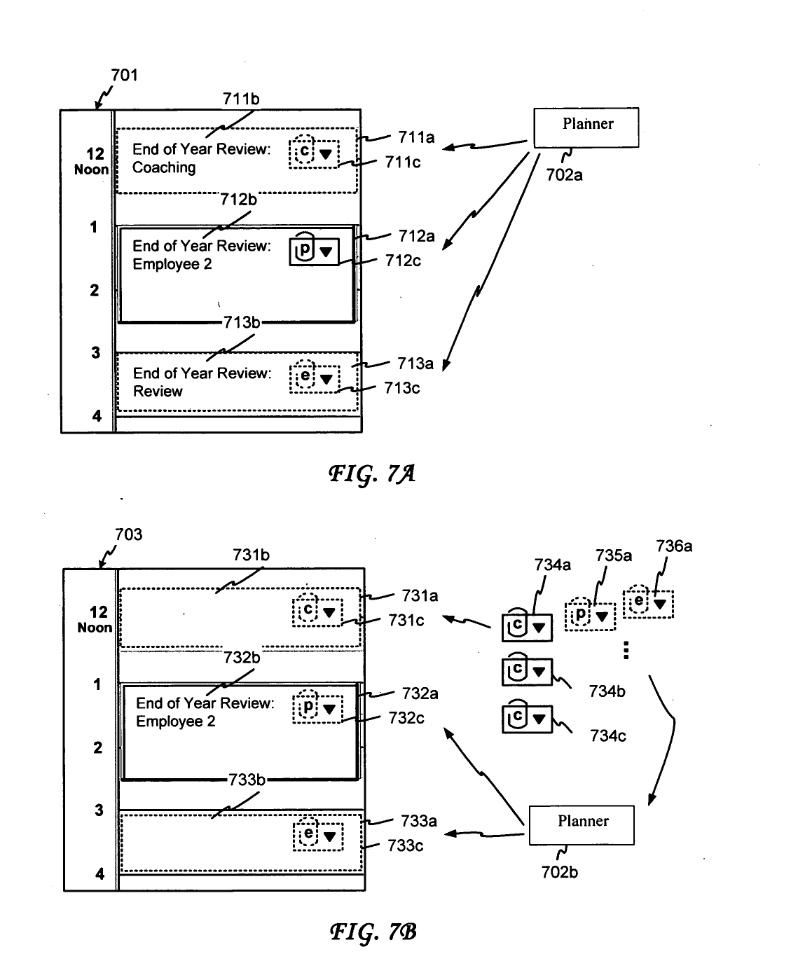

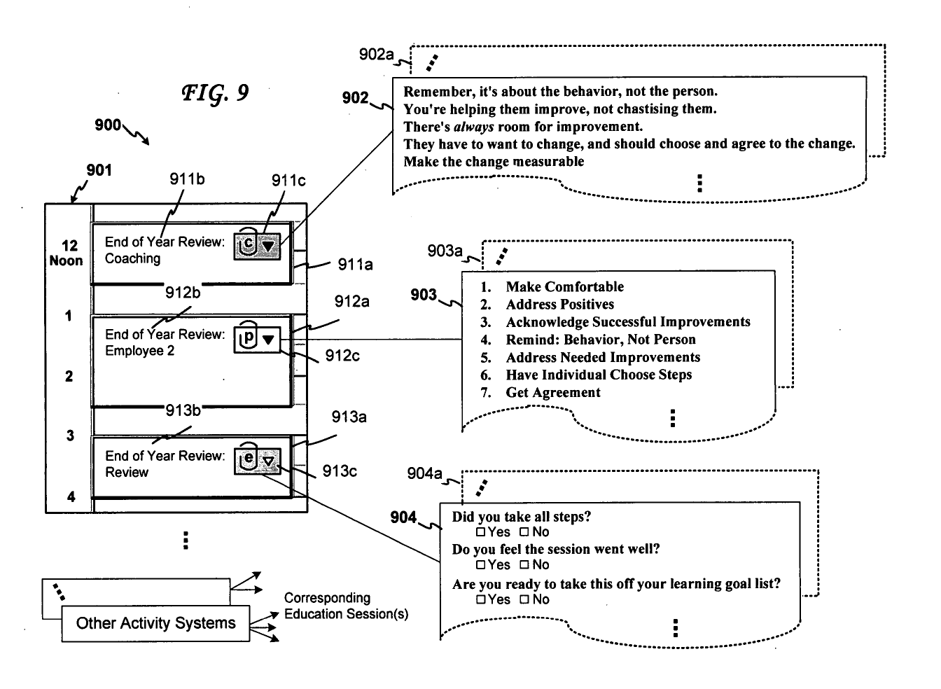

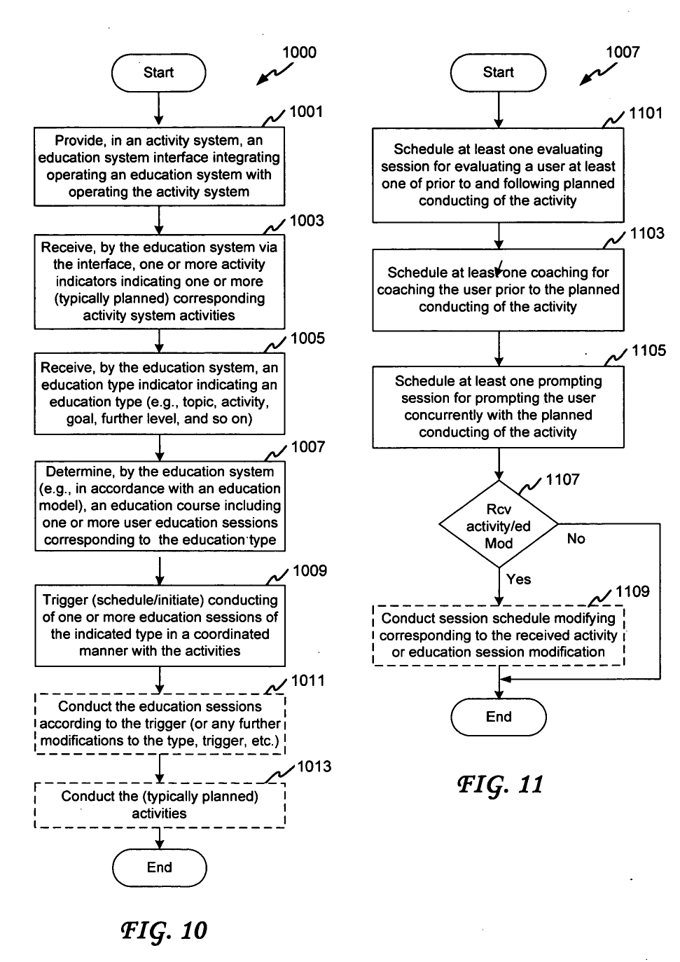

Controller 304 is also operable in conjunction with scheduling or presentation features that are provided externally, for example, by an activity system, or internally by components 302 and 303. Where user learning is scheduled via an activity system scheduling feature (e.g., calendaring or other timing features), controller 304 further provides for transferring education scheduling information from scheduler 354 via APIs 321 to activity system 301 (e.g., see FIGS. 6B-7B). Where education session presenting is conducted via activity system 301 utilizing education session information provided by teaching engines 305, controller 304 provides for transferring corresponding learning content or other learning information from at least one of evaluator 351, coacher 352 and prompter 353 via APIs 321 to activity system 301 (e.g., see FIG. 9).

Controller 304 also provides for initiating and receiving externally stored learning information from loader 323 of education integrator 302, and storing control-related learning information in control information storage 345 or storing scheduling, evaluating, coaching or prompting information via corresponding components 351-353 in respective storage 361, 362, 363 or 364. Controller 304 further provides for similarly initiating saver 324 to transfer user responses, session statistics or other learning information to an external system. (It will be appreciated that conducting of security, data conversion, communication, information transfer, and so on with an external system are otherwise well known, and may be conducted in an otherwise conventional manner, but in conjunction with loading or saving of learning information.)

Within controller 304, initiator 341 provides for initiating one or more of education integrator 302 or education manager 303 components. For example, initiator 341 responds to a launch indicator from activity monitor 322 that an activity system has been initiated by initiating APIs 321 to retrieve from integration information storage 315 and integrate into to the activity system the aforementioned learning or “education” interface. Initiator 341 further responds to an activity event by initiating planner 342 or implementer 343, which provide for scheduling or conducting of integrated learning (e.g., see below). Initiator 341 also provides for initiating APIs 321 for transferring scheduling, content or other learning information to an activity system where respective scheduling or presenting is conducted via the activity system, or otherwise, for initiating one or more other programs for conducting scheduling or presenting, or initiating one or more learning system programs (which programs can further correspond to one or more activity systems) for conducting such scheduling or presenting.

Initiator 341 further provides for responding to a content indicator from APIs 321 indicating that (initially presented or further presented) learning content is needed for presentation to a user by initiating a suitable education content providing component. Initiator 341 is, for example, configurable for responding by initiating at least one of teaching engines 350, or by initiating loader 323 for receiving education content from an external system, in accordance with the requirements of a particular application.

Among other advantages, accessing of initial or subsequent learning information or portions thereof from an external system, such as a learning server or other more capable user device, enables the providing of more data intensive or media rich integrated learning in conjunction with less capable user devices having fewer memory/computational resources but having a suitable display, speakers, program code or other presenting features for presenting such information (e.g., less powerful cell phones, PDAs, handheld computers, and the like). Education information can, for example, be provided to such devices in fixed or variable sized amounts or complexities (e.g., buffering within a user device amounts of learning information for which memory resources are available, using text, filtered or otherwise processed graphics or speech synthesis for user presentation, versus corresponding video, audio, complex graphical portion, animation, etc., requiring a more capable display or other presentation components, and so on).

Among the remaining controller 304 components, planner 342 provides for determining education session plan information according to which one or more corresponding user education sessions are scheduled (e.g., one or more of a number of sessions of each type in a course, the session order, timing/event(s) between or for initiating a next session, and so on), or further, for determining a planned or actual user education schedule. (A planned education schedule is preferably subject to user selection, modification, acceptance or cancellation by parameter, session, session type, session level or course. Once accepted, a planned education schedule becomes an actual one.) Planner 342 further provides for conducting education session schedule monitoring and initiating of user education on a session due date where a corresponding activity system does not provide for or is otherwise not used for scheduling in accordance with a particular application.

Planner 342 responds to initiator 341 by initiating scheduler 305, receiving from scheduler 354 education session plan information, and providing to APIs 301, the session plan information, which is presented to the user by activity system 301 or by APIs 321 (e.g., see FIG. 4B). Depending on the implementation, the session plan information preferably includes session information that the user may schedule or a planned session schedule that the user may accept, reject or modify. Implementer 343 provides for implementing a education session schedule via APIs 321 within activity system 301 or by APIs 321 (e.g., see FIG. 4A).

Configuration manager 344 provides for storing and retrieving of user options (including any user preferences), an applicable learning model or other learning integration system parameters for configuring education manager 303 operation. During learning system startup, configuration manager 344 transfers from control information storage 345 learning parameters to education engines 305a including planner 342 (i.e., and scheduler 354) and teaching engines 305 for implementing a particular learning model in accordance with user preferences. Thereafter, configuration manager 344 responds to user selection of user options that modify the education engine configuration via the aforementioned user interface (and further via APIs 321) by transferring to corresponding ones of education engines 305a the configuration modifications, and further storing user preference or other education integration system configuration information in storage 345.

Education manager 303 also includes scheduler 354, teaching engines 305 including evaluator 351, coacher 352 and prompter 353, and education storage 306a including scheduling information storage 364 and education content storage 305. Education content storage 305a further includes evaluation information storage 351, coaching information storage 352 and prompting information storage 353. (It will be appreciated that one or more of integration information storage 325, control information storage 345, education content storage 306 and scheduling information storage 364 may be combined to form an education storage or otherwise re-configured in a more integrated or distributed manner, as may other of system 300 components, in accordance with the requirements of a particular implementation.)

Scheduler 354 provides for determining and returning to planner an education schedule. More specifically, scheduler 354 responds to planner 342 by determining an education session schedule plan which plan is preferably made according to a current learning model and any applicable user preferences and is further subject to user modification (e.g., changes, canceling, accepting, and so on). A plan may affect one or more education sessions at a time, in accordance with the requirements of a particular application.

In the present example, scheduler 354 receives from configuration manager 344 (via planner 342) a scheduling parameters of a current learning model and any user preferences affecting session scheduling. Scheduler 306 further receives from planner 342 (via APIs 301 an activity due date (e.g., at least one of a time, date, time preceding/following one or more OS or ordinary/learning activity events, and so on) a topic, or further, an education level (see below). Scheduler 354 further calculates, according to the received information, a session schedule. The session schedule is more preferably configurable for providing deterministic learning (in which an attempt is made to complete an education “course” in conjunction with a user-selectable or “determined” completion date) or opportunistic learning (in which a pacing or completion of education is variably determined according to opportunities for using ordinary activities as learning examples). It will be appreciated, however, that one or more of these or other approaches may also be used. Scheduler 354 stores the education session schedule (plan) in scheduling information storage 364.

Scheduler 354 further responds to a planner 342 request for the stored education session schedule by retrieving such schedule from scheduling information storage 364. Storing of the education session schedule enables a user to modify (via the above interface) an education session schedule in manners not enabled by conventional scheduling programs, such as calendars. For example, a user may modify a session, sessions of a selected type (see below) or all sessions corresponding to a current education course that comprises the education sessions. Such modification may then be transferred (via APIs 321) to the activity system, where the activity system provides a suitable scheduling feature, to another program that provides a suitable scheduling feature or to an API provided program having such a feature (e.g., see below).

Scheduler 354 storing of the education session schedule also enables scheduler 306 to operate as a monitor in conjunction with a corresponding activity system that does not provide a suitable scheduling feature. In such cases, scheduler 354 may, for example, poll a timing system of the user device (or an external device) for timing information which scheduler 354 compares with education session due dates of the session schedule, or scheduler may respond to user device (e.g., OS or local/remote program) timing or events and send an indicator to implementer for initiating a corresponding education session. One or more of these or other otherwise conventional mechanisms for providing such schedule monitoring can also be used in accordance with a particular application.

Evaluator 351 provides for conducting one or more types of evaluating of a user's preparedness, education level, learning, conducting of an ordinary activity or attaining of user goals with regard to a learning type. Evaluator 351 conducts such evaluating at least one of initially and in conjunction with and preferably also after the conducting of at least one corresponding ordinary activity or education session (e.g., on an ongoing basis), or more preferably, both initially and on such ongoing basis.

Evaluator 351 responds to a user selection, an activity system generated activity event (via APIs 321 and implementer 322), stored session plan information (via planner 342) or a request for further user or user device evaluation learning information (via APIs 321). Evaluator 351 responds by presenting evaluation learning information. Such presenting includes retrieving such information or a prior evaluation from one or more of evaluation information storage 361 and an external system (via implementer 343 and loader 323), and transferring corresponding evaluating content via implementer 343 to APIs 321 for presentation (e.g., by the activity system, another program or a program provided by APIs 321). (As will be discussed, evaluator 306 also provides for conducting different levels or types of evaluating.)

Such evaluator presenting further includes evaluator 351, in conjunction with receiving user responses from APIs 321 via implementer 343, analyzing the user responses in accordance with predetermined criteria, causing further evaluation information to be presented to the user as needed or causing scheduling of further user evaluating or further coaching, prompting or modifying of further scheduled coaching or prompting sessions (e.g., by initiating implementer 343, which further correspondingly imitates one or more of planner 342/scheduler 354, coacher 352 or prompter 353). Evaluator further stores evaluation results or user responses (e.g., for statistical use) in evaluation storage 364 or to an external system via saver 324.

It should be noted that certain advantages are enabled where evaluator 351 or other learning system components are configured for a preferred interactive presenting of learning content. In interactive presenting, a user receives and responds to only a portion of evaluating or other corresponding content at a time, as contrasted with an asynchronous or “complete” presentation in which a user receives and then responds to substantially all content corresponding to an education session. For example, a user (or a resource limited user device) may be provided with or respond to only currently relevant learning information, which information may, for example include statically provided or streamed multimedia information.

Among still further enabled advantages, providing for interactive presenting also enables evaluator 351 to provide for determining an evaluation result of one or more of an initial or intermediate user response (e.g., by analyzing such response(s) according to predetermined analysis parameters) and providing or not providing further evaluation information in accordance with such result (e.g., canceling, appending or modifying scheduled evaluation information). However, evaluation may also, due to device resource limitations (e.g., low throughput data transfer) or otherwise in accordance with a particular application, be conducted more asynchronously or some combination, for example, in accordance with a user device, learning considerations or other requirements of a particular application.

Evaluation may, for example, include presenting an evaluation questionnaire to a user and comparing user responses (e.g., one or more of selected answers/media, parsed text, and so on) with predetermined answers; evaluator 351 may further compare one or more of specific answers or one or more matching answer tallies with predetermined static, weighted or other evaluation criteria or algorithm(s) to produce an evaluation result. The evaluation result may further be compared to evaluation response criteria for determining a suitable evaluation based action (e.g., one or more of repeating a session, presenting a further or next session using more/less or different content at the same or another level or using the same or different media, course completion, and so on). It will be appreciated that a wide variety of evaluation mechanisms may be used in accordance with user information, course/session information or other requisites of a particular application. It should further be noted that an evaluation mechanism or criteria for performing evaluation may be integrated within a learning model (e.g., enabling intra-course evaluation continuity, more comprehensive course planning, statistical review, and so on) as well as otherwise within an education system (e.g., enabling inter-course continuity/planning, statistical review, and so on).

Coacher 352 and prompter 353 are operable in a similar manner as with evaluator 306. Both provide for responding to a user or education session schedule initiating by determining learning information (education content) to present to a user, retrieving such information from a corresponding education information storage or an external system (via implementer 343 and loader 323), and presenting such information to a user in a preferably interactive manner. Both are further similarly capable of providing a type or level of learning information in accordance with an education course, scheduling, prior evaluating by evaluator 351 or user preferences.

Coacher 352 provides for determining user training education information or “coaching” to be conducted corresponding to one or more activities, and further, for conducting such coaching in accordance with an education session plan. Coacher 307 provides, for example, for responding to a user selection, activity system generated activity event (via APIs 321 and implementer 322), stored session plan information (via planner 342) or a request for further coaching education information (via APIs 321) by retrieving such information corresponding to a current course and session, or further, one or more session portions or “session presentations” (e.g., see below) from one or more of coaching information storage 361 and an external system (via initiator 341 and loader 323).

As with evaluator 351, coacher 352 may further respond to modifications by providing more, lesser or otherwise modified coaching content. A modification may, for example, occur by user or activity system addition of a further corresponding ordinary activity, canceling of an ordinary activity/education session or course, other activity/education modification or other activity event, or in accordance with conducting of an evaluation by evaluator 351, any one or more of which might impact a session plan or execution of a learning model.

Prompter 353 provides for determining learning information to be provided during or otherwise in conjunction with a user conducting an ordinary activity or as otherwise desired (referred to herein as “prompting”), and for conducting such prompting in accordance with an education session plan, activity event, learning model or as otherwise requested by a user (e.g., see FIG. 9). The prompting learning information or prompting content may, for example, include a summary, review, overview, reminder, todo list or other prompting information, typically for preparing or assisting a user in conducting the corresponding ordinary activity.

Prompter 353 provides, for example, for responding to a user selection, activity system generated activity event (via APIs 321 and implementer 322), stored session plan information (via planner 342) or a request for further prompting information (via APIs 321) by retrieving such information corresponding to a current course/session, or further, one or more session portions or “session presentations” (e.g., see below) from one or more of prompting information storage 363 and an external system (via initiator 341 and loader 323).

As with coacher 352, prompter 353 may also similarly respond to ordinary activity/learning modifications that might impact a session plan or execution of a learning model, and may respond to a user selection or activity system generated activity event (via APIs 321 and implementer 322), stored session plan information (via planner 342) or a request for further prompting information (via APIs 321) by retrieving such information from one or more of prompting information storage 363 and an external system (via initiator 341 and loader 323).

FIG. 3B illustrates an education model according to an embodiment of the invention. Education model 346 is preferably loaded or received, as was already discussed, and a user copy (user learning model) is preferably created and modified according to user preferences, scheduling, and so on of each user using the learning model, and then stored. The copy is then loaded and executed (e.g., distributing its components to corresponding ones of learning system 300 components as needed for conducting corresponding user learning.

The present learning model example is configured as a combined linear and tree configuration including N+1 education sessions (sessions) corresponding to a selectable education course in a selectable education topic at a selectable education level. (Alternatively, one learning model or one or more sessions may correspond with or include more than one education topic, level or user parameters, or may utilize one or more of linear, tree or other configurations.) Education sessions may also be configured in an identical manner, as in the present example, or may be configured differently, for example, in accordance with level-of-difficulty, content amount or other applicable session constraints. Cross-model sessions (that may refer to another model or otherwise link two or more models) may also be used, for example, to supplement a course/session(s) or otherwise coordinate courses/session(s).

In order to provide a better understanding of learning model configuration, an exemplary substantially complete model configuration is illustrated in which: session-1 346a depicts a common session structure and session-N 346c depicts activity and content details, both of which may be applicable to all sessions; the remaining sessions 346b, 346d are illustrated in only summary form. Learning model 346 more specifically includes a variably executable sequence of similarly configured sessions including a first or “initial” session-1 346a that begins a course or course portion. Learning model 346 also includes a “next” session-2 346b and “later” session-N 346c, assuming that session presenting proceeds linearly, and a last or “end” session 346d that concludes a course or course portion. (It will become apparent, however, that configuration, scheduling, content, linking or other model attributes may be varied in accordance with the requirements of a particular application.)

Beginning with education session-1 346a, each session may include a session activity, session content, schedule parameters and evaluation parameters. A session activity (e.g., 371, 381, 391, 381a) may include session parameters indicating a session type, an anchor activity indicator indicating whether an ordinary activity (anchoring activity) should or must be used in conjunction with the session activity (anchored activity), if available, an ordinary activity type descriptor indicating one or more applicable ordinary activity types, and a session topic or level (if used). Session types for the present embodiment include evaluation, meta evaluation, coaching and prompting (which are discussed separately herein). An anchoring activity includes an ordinary activity of a given type to which one or more education activities of an education session may correspond, for example, using the ordinary activity as a real-world teaching example (e.g., as with a fictitious word problem or hypothetical). Suitable ordinary activity types may, for example, include actual/scheduled email, voice-mail, meetings, conferences, projects, vacation planning or other activities of a single user or interacting users to which education may be applied. A session topic may include a sub-topic within a course or may link a session to a course having a corresponding or same topic, while a session level may indicate one or more difficulty content or other course/session distinctions that may be linked, alternatively presented and so on. (For clarity sake, only one session level is depicted with the understanding that additional levels may be added using simple replication, addressing, database processing or other well-known techniques.)

Educational content (e.g., 372, 382, 392a, 392b, 382a) may include one or more of educational data portions, such as a lesson, annotations, parameters for analyzing text or other multimedia according to analysis of one or more field, musical phrase, image/video segment, title, style, comment, note, scheduling, and so on, accompanying multimedia explanation, dictionary/thesaurus, and so on (e.g., 373a), and links to multimedia data stored on an external system (e.g., 373b). Education content may also include more than one topic, level or multimedia type, the same or different faux, anchored, pre-session or post-session educational data or other data alternatives (e.g., see session-N below), one or more of which may be presented in conjunction with an educational session. (Education content provided by a received learning model is more preferably stored in a corresponding teaching engine storage, such as evaluation, coaching or prompting information storage 306 of FIG. 3A, and retrieved for presentation as discussed elsewhere herein.)

Schedule parameters (e.g., 373, 383, 393, 383a) provide for establishing criteria according to which one or more education activities of a first session, current session, next or other successive session or last session may be presented. For example, a scheduling parameter may indicate a predetermined minimum or maximum absolute or (more typically) relative time interval (presentation period) during which a search may be made for a suitable available ordinary activity event to be used as a teaching example opportunity. A minimum and maximum time or other criteria may also be used to define a presentation period during which a session should be presented alone or in conjunction with an ordinary activity. (If such a time interval does not provide such an opportunity, for example, a user is on vacation, has a distant meeting, has a full calendar or is otherwise unavailable, then another time interval may be considered, a faux activity may instead be scheduled or a user may be alerted.) A faux activity may, for example, provide for keeping learning active during periods in which ordinary activities are insufficient to provide sufficient practice. The specific parameters may also be configured as user modifiable, for example, enabling a user to expand or contract a minimum/maximum time between sessions, between pre-sessions, sessions and post sessions, and so on. (Schedule parameters provided by a received learning model is more preferably stored in a corresponding scheduling information storage, e.g., storage 364 of FIG. 3A, and retrieved for conducting scheduling as discussed elsewhere herein.)

Evaluation parameters (e.g., 374, 382, 394, 382a) provide a mechanism for analyzing user progress with regard to one or more sessions, topics, levels of difficulty, and so on. Evaluation parameters may, for example, include but are not limited to comparative data against which user responses to presented questions or other evaluations may be compared, sufficient completion, time interval for completion or education activity/session restart occurrences (if an implementation so provides) of one or more consecutive, topical, level or other sessions may be determined. Evaluation parameters may also include one or more evaluation algorithms for conducting the above evaluations, for reviewing user work product (e.g., inclusiveness, grammar, spelling, and so on) or for conducting other evaluation of one or more user conditions, ordinary activities or education activities.

Evaluation results may further be used to provide user feedback (e.g., score or other multimedia motivational stimulus) or to affect a progression of user advancement through course sessions, for example, repeating a session 373a, providing one or more supplementary sessions 374b or advancing a user to a next session 374c. Advancing may further include conjunctive advancing to an adjacent session such as a next session in a linear course progression or disjunctive advancing (e.g., skipping) beyond an adjacent session, to a different level, to a different session/course progression and so on. Reporting of evaluation results or other evaluation information reporting may also be conducted for assisting a user, other users, education system usability or suitability (e.g., generally or according to an age/maturity, level or other suitable characteristic), and so on. Various combinations may also be employed in accordance with the requirements of a particular application. (Evaluation parameters provided by a received learning model is more preferably stored in a corresponding education information storage, e.g., storage 361 of FIG. 3A, and retrieved for conducting scheduling as discussed elsewhere herein.)

Continuing now with the activity and content detail of session-N 346c, at least each session that may be utilized in conjunction with an anchoring ordinary activity preferably includes an anchor education activity (e.g., activity-N 391a) and a faux activity (e.g., 391b). The anchor education activity is preferably executed in conjunction with a suitable ordinary activity that may be available during a target time interval for presenting an education session. Alternatively, a faux activity may be executed if an ordinary activity is unavailable. (As discussed elsewhere herein, an anchor activity indicator may be added to a corresponding ordinary activity event, while a faux activity may be added as an ordinary activity event, or further, provided with an education indicator).

While an anchor education activity and corresponding faux education activity may share content in certain cases (e.g., during prompting or evaluating portions), the present model also provides for separate anchor and faux activity content (e.g., 392a, 392b) that may be used in an alternative or combined manner. For example, an anchor activity may merely supplement corresponding ordinary activity information (using the ordinary activity as a working example), while a faux education activity more typically operates as its own working example where no suitable ordinary activity is available during a target time interval (presentation period). In such cases, sufficient content for conducting a faux activity may be stored as faux activity content and supplementing anchor activity content may be used to supplement stored faux activity content. External content may be also used (e.g., see above) or some combination of stored and external content may be used.

Session-N 346c also illustrates how model 346 further provides for executing a complex session that may include one or more of a main session (e.g., an anchored or faux session) as well as one or more pre-session or post-session activities. Among other uses, the illustrated session structure provides for facilitating learning and course preparation. For example, in one embodiment, a pre-session provides for preparing a user for presentation of a main (and typically an anchored) session by presenting preparatory education content, and a post session provides for presenting supplementary or closure providing education content to the user. While typically non-anchored, one or more pre or post sessions may also include one or more anchored activities. In another embodiment, pre, main and post sessions provide for linking of coaching, prompting, evaluating or other education types with one or more common ordinary activities. For example, a user meeting (ordinary activity) may be preceded by a coaching session, coincident with a prompting session and precede an evaluation session or such sessions may be associated with multiple meetings, meetings and phone calls, or other related ordinary activity combinations so that more effective and relevant learning may be provided. One or more of the pre, main and post sessions may further be associated with corresponding pre-session content (e.g., 392b1), post session content (e.g., 392b2 and main session content (e.g., anchor content 392a1 and faux content 292a2). Scheduling parameters are also preferably provided for determining scheduling of pre-sessions and post-sessions for execution. Such scheduling parameters typically provide for establishing some time interval for conducting a pre/post session activity relative to a main session.

FIG. 4A, with reference to FIG. 3, illustrates an example of APIs 321 in greater detail. In this example, APIs 321 include interface embedder 321a, schedule integrator 321b, activity information retriever 321c, presenter 321d, converter 321e, data state indicator 321f, program implementer 321g and program launcher 321h.

Interface embedder 321a provides for embedding a user education interface within a corresponding activity system or other program code used to provide an education interface. Interface embedder 321a more specifically responds to activity monitor 322 detecting of a user or user system initiation (e.g., launching) of an activity system in an otherwise conventional manner (e.g., via OS message retrieval or interception) and, unless user preferences require prior user selection or confirmation, responds by inserting one or more menus or other suitable user interface components into the activity system in an otherwise conventional manner.

The user interface may, for example, include one or more of learning menus, the operating of which by a user causes activity events or other suitable menu selection indicators to be generated (and which generating can be detected by activity monitor 322). The user interface provided by interface embedder 321a further preferably includes embedded schedule indicators indicating scheduled education sessions, which schedule indicators are more preferably provided by schedule integrator 321b. The user interface, as discussed earlier, may further include other interface elements or a complete user interface, for example, where the education system provides for scheduling or presenting of education activities (e.g., see FIGS. 6A1-6A6).

Schedule integrator 321b provides for embedding one or more session schedule indicators within a corresponding activity system or other program code used to provide for education scheduling (e.g., see FIGS. 6B-7B). Among other advantages, embedding scheduling indicators within an activity system otherwise used for scheduling ordinary activities enables a user to view scheduled education sessions, or to further modify one or more sessions, in substantially the same manner as the activities. Schedule integrator 321b responds to planner 342 or corresponding education interface element selecting by embedding the session indicator(s) in the activity system or other program code in an otherwise conventional manner for conducting embedding. The embedded session indicators may then be moved or otherwise modified in the same manner as with activity system activity indicators, or by selecting a corresponding education menu option. Where such option is selected, schedule integrator 321b responds to planner 342 (which responds to the menu selecting) by correspondingly moving or otherwise modifying one or more of the education session indicators.

Activity information retriever 321c provides for retrieving activity system information for use in conjunction with activity system operation where such information is not otherwise provided by way of activity events. Such information may, for example, include education system scheduling information where, for example, a user has selected one or more corresponding activities and indicated (e.g., via the aforementioned user interface menus) that learning is desired. Activity information retriever 321c responds (typically to planner 342) by retrieving from the activity system activity information indicating scheduling of the corresponding or other activities (e.g., by memory polling or request to the activity system) in an otherwise conventional manner, and transfers the scheduling information to planner 342.

Presenter 321d provides for presenting one or more education sessions to a user via a corresponding activity system, further launched presenting program or program provided by program implementer 321f. Presenter 321 responds to implementer 343 by providing education content also received from implementer 343 or loader 323, or by receiving and providing to implementer 343 user responses in an otherwise conventional manner. (Presenting is discussed in greater detail below).

Converter 321e provides for modifying a form or content of data transferred between an activity system (or other launched program) and the education system from a that used by the transferor to that used by the transferee. Converter 321e, for example, responds to an initiating education integration system component including a transferor indicator and data by performing a predetermined conversion (e.g., by at least one of looking up a corresponding form/content, applying an algorithm and otherwise in a conventional manner). Converter 321 also similarly responds to the selecting of an indirect education indicator, such as an activity detail indicator, by determining a corresponding learning type indicator and transferring the learning type indicator to planner 342 or implementer 343 (e.g., see FIGS. 6A1 and 6A3).

Program launcher 321f provides for initiating program code of a program used for scheduling or presenting or for providing other features, where scheduling, presenting or other features of activities or education are not conducted by a corresponding activity system. As is discussed elsewhere in greater detail, many otherwise suitable activity systems do not provide for such scheduling of activities or for presenting of other than activity information, and, while providing of such features would desirably be conducted by an activity system with regard to learning, no such activity systems have been identified. (It may also be undesirable for a corresponding activity system to do so in accordance with the requirements of a particular application.) Therefore another program might be desirably used for such purposes.

Program launcher 321f provides for responding to implementer 343, presenter 321d or planner 342 by initiating operation (“launching”) of a predetermined or selected program for conducting features and initiates interface embedder 321a for embedding a corresponding learning interface within such program in cases where a learning initiating program does not provide a feature but another available program does provide such feature. (It will be appreciated that launching a program may be implemented by an OS call or other conventional mechanism.) Program launcher 321f instead initiates program implementer 321g where included parameters indicate that no such available program exists or no such available program is found responsive to program launcher initiating (e.g., where program launcher 321f receives a corresponding system error.)

Program implementer 321g provides for initiating included program code (or code received from an external system) for providing activity or education features that preferably are not provided by a corresponding activity system or another available program. Program implementer 321g otherwise operates in a similar manner as program launcher, responding to implementer 343, presenter 321d or planner 342 by initiating operation (“launching”) of the included program in an otherwise conventional manner.

Turning now to FIG. 4B, a scheduler example corresponding to scheduler 354 of FIG. 3 will now be discussed. Scheduler 354a of FIG. 4B includes user preferences engine 342a, activity due engine 342b, overlapping education engine 342c, dependency engine 342d, planner control engine 342e and scheduler 342f.

User preferences engine 342a provides for retrieving from control information storage 345 and providing to scheduler 305 user scheduling or other education session/course preferences impacting scheduling of one or more education sessions. For example, user preferences engine 342a provides for receiving user preferences indicating one or more of an absolute or relative date, time, time period, event, min/max range or other parameters according to which a session might be conducted. User preferences can thus be provided directly by the education system (e.g., planner 342) for determining an education schedule, for example, where such scheduling is not conducted via an activity system or otherwise in accordance with a particular implementation.

User preferences engine 342a also provides for retrieving user preferences that may indirectly affect such scheduling, including but not limited to selecting a learning type, level or configuration having few activities/sessions, use of only one or more particular user devices or security for presenting education, and so on. User preferences may also affect the education content of one or more education activities/sessions, whether one activity/session will be considered as impacting the schedule, content or other aspects of user learning, among others (see, for example, preferences below).

Activity/education due engine 342b provides for receiving and providing to scheduler 354 activity scheduling information received by activity information retriever 321c or schedule integrator 321b of APIs 321 (FIG. 4A). Activity/education engine 342b also operates as an education system timing mechanism where education session schedule implementing is conducted by the learning system.

In this example, activity/education due engine 342b polls education schedule information for scheduled education sessions stored in control information storage 345 (FIG. 3) on one or more of a periodic and event driven basis, compares an included session due indicator with a system timing indicator (e.g., time and date) and, when it determines that the “session due time” (e.g., time, date or both) is/are near or in conjunction with the session becoming due, provides indicators to implementer 343 identifying the session and its corresponding timing status. (Implementer 343 then initiates a corresponding one or more of APIs 321 or learning systems 305a respectively to notify the user or initiate presenting of the corresponding education session.)

Overlapping education engine 342c provides, if overlapping education of different types is enabled (e.g., as a user preference), for determining scheduling of any overlapping sessions or of resolving conflicts due to such overlapping sessions. Operationally, overlapping education engine 342c responds to schedule integrator 321 or scheduler 354 (FIG. 4A) by receiving from scheduler 354 current session schedule information, determining therefrom whether an overlapping schedule exists. Overlapping education engine 342c further, if overlapping sessions are enabled, determines from the current schedule information a schedule enabling any conflicts with user preferences, education parameters, and so on to be resolved. If overlapping education engine 342c can produce such a schedule, then it transfers the schedule to scheduler 354; otherwise it returns an error indicator to scheduler 354. (Scheduler 354 further responds by initiating via implementer 343 and APIs 321 a user notification corresponding to the error, from which the user might yet accept an erroneous schedule, modify user preferences, reschedule, cancel or otherwise modify one or more session course, ordinary/education activity scheduling, and so on.

Dependency engine 342d provides, if dependent sessions are enabled (e.g., as a preferred default or further user preference), for causing the results of one or more prior education sessions to affect the scheduling or content of one or more later education sessions. Operationally, dependency engine 342d receives from an evaluating, coaching, prompting or other learning system component in conjunction with conducting of an education activity/session at least one education activity/session result indicator indicating results of an education session or portion thereof that has been conducted. The result indicator may, for example, indicate that the education session was not sufficiently completed, user evaluation results suggest repetition or added education, and so on.

Dependency engine 342d responds to receiving the education session result indicator or “result indicator” by analyzing the result indicator in a predetermined manner, determining whether a currently scheduled education session time or content requires modifying, and if so, transfers a modification indicator indicating such modifying to activity due engine 342b. Activity due engine 342b retrieves a current session schedule and provides the schedule for modification to one or more of scheduler 354 (where analyzing indicates that a session schedule should be modified) and learning system 305a components (where analyzing indicates that education content should be modified). Any modification is then preferably conducted, if at all, in accordance with the learning model (e.g., which may cause changes to be permitted or inhibited according to predetermined criteria for evaluating whether user/system changes may more positively, negatively or neutrally impact learning).

Of the remaining planner 342 components, planning control engine 342e provides for controlling the operation of the other planner 342 components. Schedulers 354a and 354b are configurable for providing learning according to different learning approaches that may be predetermined, user-selectable or calculable according to one or more of due date, presentation period and other scheduling learning parameters.

Deterministic scheduler 354a more specifically provides for receiving an ordinary activity indicator (or user selection) including a corresponding end of course or last session due date. Deterministic scheduler 354a responds by receiving education parameters from a current learning model, including scheduling parameters, and attempting to determine a schedule for causing completion of a course to occur on or before the due date. Various mechanisms may be used to determine such scheduling. For example, the course may include anchored activities that are preferably presented during or at some other due date corresponding to a due date of an anchoring ordinary activitiy. Strict adherence to such anchoring would fail to produce an education schedule unless corresponding ordinary activities are available, while a learning system supporting faux activities may add faux ordinary activities to which education activities may then be associated. (Faux activities may, for example, be used in conjunction with a given learning approach where sufficient available activities that correspond with the learning activities according to one or more of due date, type, level or other learning parameters.) Deterministic scheduler 354a may also attempt to produce a schedule using one or more education activities having a different education level, or other schedule fitting may also be used. Upon a failure to set a schedule, deterministic scheduler 354a preferably alerts a user (who may, in one embodiment, select education activities or scheduling of activities via the activity system or learning interface, for example, as is discussed elsewhere herein).

Opportunistic scheduler 354b provides for receiving ordinary activity events and learning information including scheduling information, and determining therefrom whether an ordinary activity may be used as an opportunity for presenting one or more pending education activities. Opportunistic scheduling, among other advantages, enables for greater consistency, reinforcement or other more optimal learning criteria to be applied, for example, by better assuring a more optimal time interval between two or more learning sessions (e.g., subject to any allowable user re-scheduling). Opportunistic scheduling also enables the use of one or more ordinary activities that may correspond to a next education activity (e.g., in time, type and so on) to be used as a real-life learning example.

In one embodiment, opportunistic scheduler 354b receives learning information from a learning model and determines whether a next education activity is an anchored activity. In this embodiment, only anchored activities are scheduled to correspond with ordinary activities, while non-anchored activities are scheduled to correspond with scheduled education activities or at times in which ordinary activities are not scheduled. Opportunistic scheduler 354b therefore determines whether an ordinary activity corresponds in time and type to the next or “pending” anchored activity. If so, then opportunistic scheduler 354b schedules the education activity at the due date of the ordinary activity. If not, then opportunistic scheduler 354b creates and schedules a faux ordinary activity (e.g., retrieving faux activity information from a current learning model or simply creating an empty ordinary activity as activity system code/data) and then schedules the education actvity at the due date of the faux activity. If one or more other activities are associated with the next education activity (e.g., as part of an education session), then anchored processing is repeated for an anchored activity. Non-anchored activities are preferably scheduled corresponding to the next activity (e.g., at a relative due date, e.g., a prior day, corresponding to a stored presentation period or relative due date). However, such education activities may also be scheduled corresponding to an unoccupied ordinary activity placeholder, a user-selectable due date or due date within a predetermined range, and so on, in accordance with the requirements of a particular implementation. (It will be appreciated that the above embodiments, other opportunistic/deterministic learning or some combination may also be used.).

The FIG. 4C flow diagram illustrates further examples of the operation of APIs 321 (FIG. 4a) in conjunction with one or more activity systems that do not provide one or both of scheduling and presentation features suitable for presenting education session (or further, activity) schedule or content information. As was discussed above, many programs that comprise activity systems do not provide for suitable scheduling or presenting of education sessions. Such programs include, for example, but are not limited to email, voice mail, certain todo lists, conferencing, web browsers, and so on, or simply programs running in an environment that inhibits such operation, or otherwise in accordance with the requirements of a particular application. As discussed, APIs 325 provide in these or other cases for initiating one or more suitable programs or for implementing such programs directly.

Within APIs 321, interface embedder(s) 321a provide for embedding an education interface within one or more activity systems 401a, 401b. Schedule integrator 321b further provides for integrating (e.g., embedding) education session schedule indicators or underlying information within an activity system. Presenter 321b also provides for presenting an education session in conjunction with activity systems 401a-401b via one or more available programs having suitable presenting features 402b or via one or more corresponding programs provided by program implementer 321g.

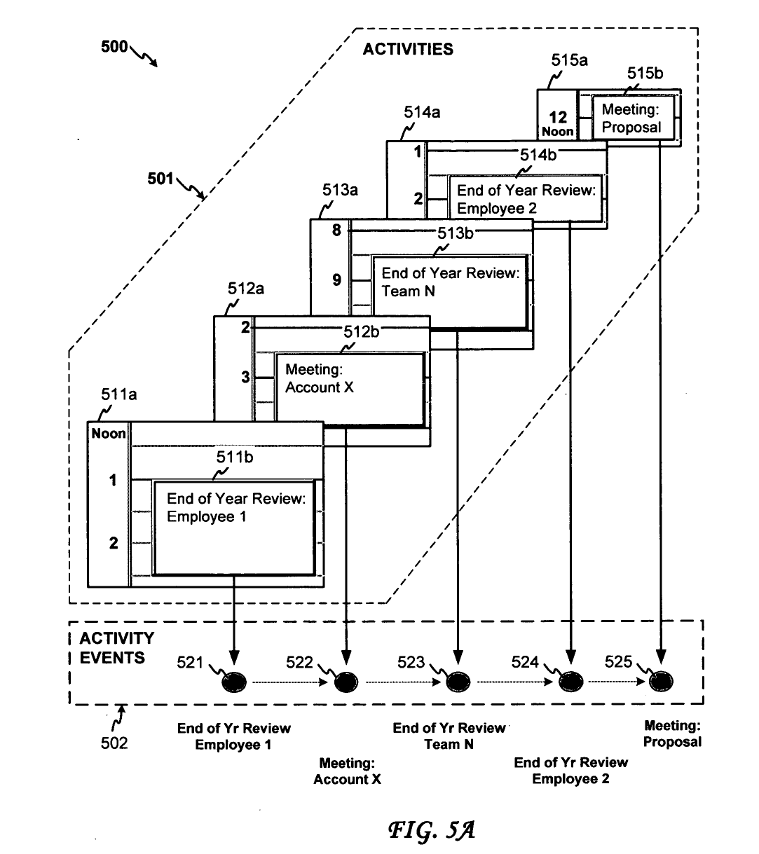

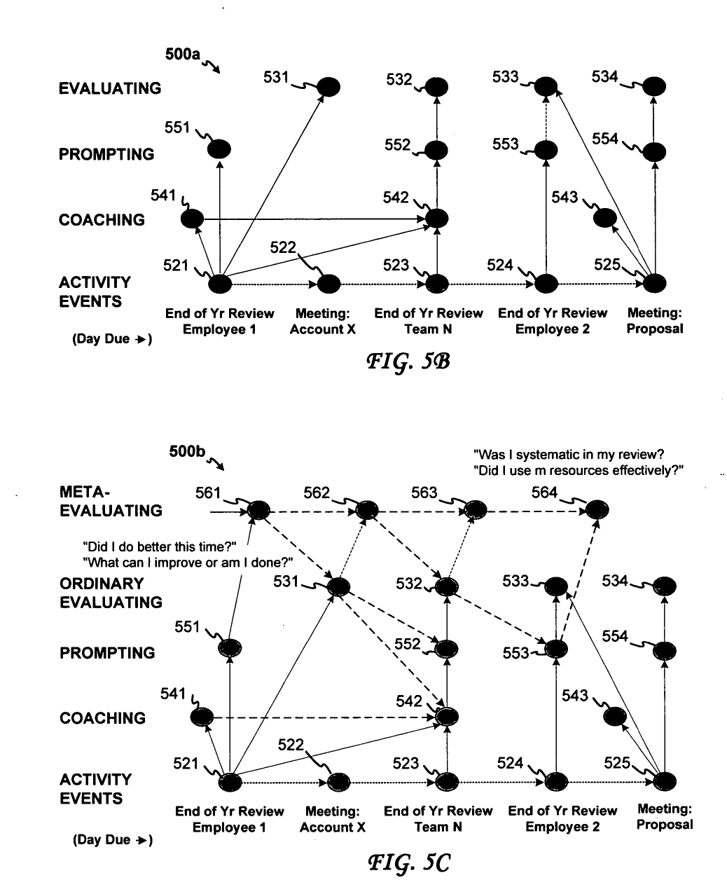

The FIGS. 5a-5c flow diagrams illustrate exemplary integrated education operation in accordance with the system implementation of FIG. 3A. For clarity sake, we will continue with the above appointment activity example as being applicable to using integrated education in conjunction with various activities, devices, and so on, and not as one intended to be construed as limiting.

FIG. 5A, with reference to FIGS. 3A-3B and 6A-6C, illustrates how the implementing of one or more ordinary activities in conjunction with an activity system 501 may result in generating corresponding activity events 502. The activity events are further received by a learning system (e.g., 302, 325, 303 of FIG. 3A), selectable ones of which are responded to by the learning system in accordance with the learning system configuration (e.g., via configuration manager 344 and configuration information stored in control information storage 345).

FIG. 6A, for example, illustrates how an activity event may be generated responsively to a user selecting an education menu item of one or more education menus integrated within the activity system, and thereby associating learning with the corresponding ordinary activity. (It will be appreciated that various other program control mechanisms or some combination may also be similarly integrated or used.) Such menus may provide for limited control (e.g., for causing education sessions to become attached to corresponding activities) or may provide for initiating complete education control (e.g., education/goal entry, scheduling, modifying, and so on) in accordance with user device resources or other requirements of a particular application.

FIG. 6B further shows how education items are preferably embedded within an activity and education session scheduling or modifying is more preferably conducted by the activity system where activity system features provide for activity embedding, scheduling or modifying. In such cases, the education system also preferably receives activity events at least upon or in anticipation of an education eactivity coming due (e.g., using conventional ordinary activity system activity monitoring and alerts to initiate corresponding ordinary/education activity events). User activity entry or ordinary/education activity modifications, among others, may also be received as activity events causing corresponding selectable education system operation, for example, where the education system conducts scheduling.

In the present example, a user initiates activities by entering into an activity system 501 (here, a calendaring program) activities according to which corresponding activity events are generated and received by education manager 304 (e.g., via education integrator 302 of FIG. 3). The depicted activities and corresponding activity events include respectively: end of year review with employee-1 511b, 521 (FIG. 4A), meeting with account X, 512b, 522, end of year review with team N 513b, 523, end of year review with employee-2 514b, 424 and a meeting during which the user will present a proposal 515b, 525.

Activity events may be generated responsive to user selection of an education menu item as in FIG. 6A, or as in the examples of FIGS. 6B-6C, the activity events may be generated responsive to the user entry or modification of the activities or already embedded education events. The example of FIG. 6A enables advantages of user control for indicating those activities for which learning is desired and, since the user indicates his education needs, requires fewer resources and is easily inter-operable with essentially all program code that might be used as an activity system. Conversely, the embedding of FIG. 6B enables a user to conduct ordinary activities in a conventional manner while also being presented with learning information, or further, while also implementing (at least scheduling of) his learning, or while enabling the user to implement his learning in a similar manner. The examples of FIGS. 6B-6C also enable advantages of automatic (i.e., programmatic) initiation of a learning availability reminder to the user, or further, automatic planning of learning. It will be appreciated that one or more such approaches can be used in accordance with device capabilities/resources or other requirements of a particular application.

Continuing with FIG. 5B, we assume for the present example that the user has elected to conduct the same education type or related learning for each of the end of year reviews 521, 523 and 524 (e.g., an education type of “conducting effective employee reviews”). The user has also elected to conduct, for proposal meeting 525, other learning of an other education type (e.g., an education type of “making a proposal”). Such user election may be made in conjunction with entering a first activity or thereafter, e.g., by selecting an existing ordinary activity and an education menu item. (A user might also elect to conduct learning where no activity exists, for example, by entering a fictitious or “faux” activity and selecting an education type.) The learning system has further responded by planning such learning, education sessions for which have been scheduled. Related or other (different) learning may also be similarly elected in conjunction with or after entering one or more other ordinary activities. The education system has also responded to each activity event by scheduling education sessions (e.g., see below), resulting in the illustrated education session example.

The exemplary education session schedule for FIG. 5B comprises, for activities 521 and 523-525 (or corresponding activity events), education sessions including evaluating 531-534 or coaching 541-543. (An exemplary passage of time, which also corresponds with FIG. 5A, is generally indicated along the positive x axis in conjunction with the further example of each activity occurring on a different day). The education sessions scheduled in response to end of year review activity event 421 may, for example, include all of the illustrated education sessions in the manner shown (as indicated by the horizontal and angled lines) or the scheduling may be modified by a user associating a same education type with an earlier activity after entering a later activity, or user modification of activity or education session scheduling.

The education system provides for tailoring each education schedule for at least one of the education type, user preferences, evaluating results, user goals, and so on, as well as the education content of an education session. Thus, for example, the illustrated education session schedule for the first education type does not include a user evaluating prior to the coaching or prompting. It does, however, include multiple education sessions that are due on the days indicated and include coaching, prompting and evaluating consisting of: a first (preceding) coaching 541 session that precedes the date of end of year review 521, concurrent prompting 551 during review 521, and a subsequent user evaluating 531 after review 421 but preceding a second activity review 523, as well as coaching 522, second prompting 452 during review 523, evaluating 532 and third prompting during review 424.

The illustrated education session schedule for the second education type is tailored to the second education type, or further to user preferences or other parameters. It includes, with respect to meeting activity 525: prior user evaluating 533, prior coaching 543, concurrent prompting 554 and subsequent user evaluating 534.

It will be appreciated that, while the present example illustrates non-overlapping education schedules for different education types, system 300 is also configurable for providing overlapping education schedules as well. It should be noted, however, that enabling overlapping schedules may create learning difficulties (e.g., overwhelming a user) or require further resources, particularly with portable computing systems where applicable data is stored on a given device. Conversely, in implementations in which scheduling is conducted by an activity system, disabling overlapping schedules may require additional code for monitoring user schedules, detecting overlapping and providing a suitable response, such as alerting the user or determining an education course/session priority and canceling of at least one of such overlapping sessions.

FIG. 5C depicts a further example of system 300 (FIG. 3A) operation illustrating how system 300 also enables variable levels of user education to be implemented either separately or in combination. For clarity sake, the activity events and session schedule of the present example are otherwise similar to those of FIG. 5B.

In the present example, multiple levels of evaluating education are separately indicated, either or both of which may correspond to the evaluating of FIG. 5B. More particularly, two levels of evaluating education, including meta-evaluating education and ordinary evaluating are both scheduled to be presented to a user. Meta-evaluating education (e.g., 561-564) presents a more particularized (objective) evaluation of a user's utilization of what he has learned. Thus, for example, system 300 meta-evaluating content scheduled for presenting (or further presented) to a user in conjunction with more effective meeting handling type education (which might be applicable to all of the activities corresponding to activity events 521-525) might include questions or other media indicating: “Was I systematic in my review?” or “Did I use my resources effectively?”. (It will be appreciated that evaluating may include one or more of self-evaluating, education system assisted or conducted evaluating and third party evaluating. So-called 360 degree approaches or other third party evaluating may, for example, utilize feedback or other information gathered from persons other than the learning system user, for example, utilizing saver 323 and loader 322 (FIG. 3A) to communicate presenting, user responses, model, content, statistics, feedback or other information to/from one or more third party evaluators or evaluation facilitators.)

Contrastingly, ordinary evaluating 531-534 provides a more reflective (subjective) review of a user's effectiveness or other aspects of his performance during the conducting of an activity. Thus, for example, system 300 ordinary evaluating content scheduled for presenting or further presented to a user (again, in conjunction with more effective meeting handling type education) might include questions or other media indicating: “Did I do it better this time?” or “What can I improve or am I done?”.

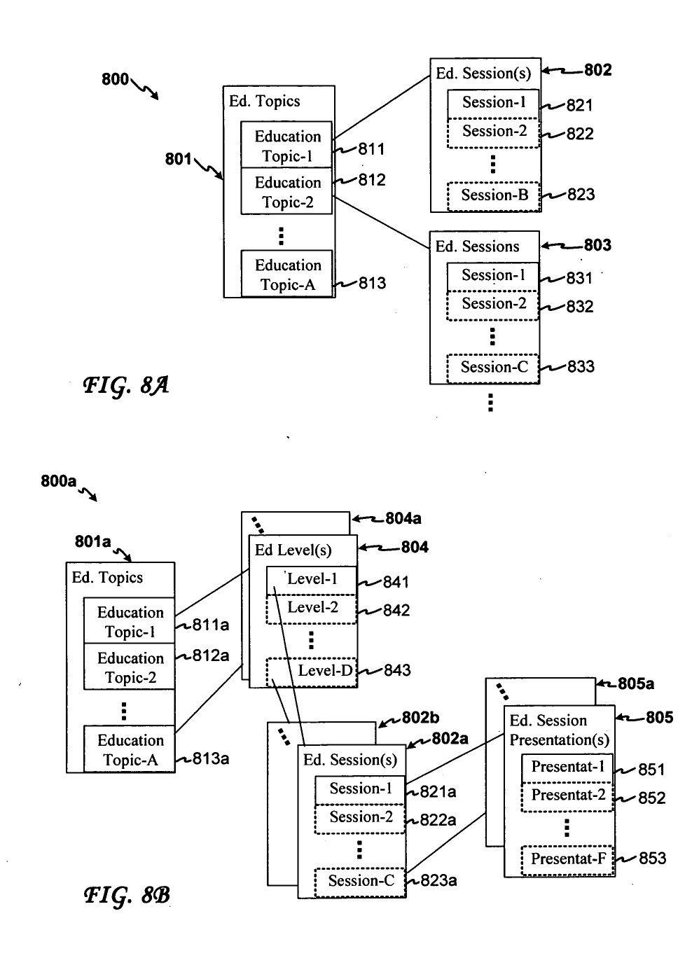

It will be appreciated that system 300 (FIG. 3A) is also similarly capable of providing differing types or levels of evaluating or other learning information in a selectable or automatic manner with regard to scheduling, content or other factors. For example, a user may select to receive an overview, an overview with links to further information or one or more other more or less comprehensive or differently presented education levels of an education type. Alternatively, planner 304 of system 300, e.g., in conducting deterministic session scheduling (or monitoring and responding to activity system based scheduling, such as given above), might determine that available time does not permit more comprehensive education and therefore determine an education session schedule (plan) including a maximum or other level of coaching that may be completed prior to scheduled user activity. A user may further elect, via setting user preferences or a session/course specific parameter, to receive a more or less comprehensive prompting during an activity (e.g., a higher level summary) that may further include or exclude links to additional details or be presented using user preferred multimedia content, among numerous other examples. (E.g., see FIGS. 8B and 9).

FIG. 5C also illustrates, by way of dashed lines, how system 300 (FIG. 3A) provides for one education session to modify scheduled presenting of one or more other education sessions of the same or a different education or session type. For example, as a result of evaluator 351 analyzing of user responses for meta evaluating 561, evaluator 351 is configurable for causing ordinary evaluating 531 to be modified (e.g., by indicating analysis results to implementer 343, which determines whether user preferences permit rescheduling, and if so, initiates planner 342 for rescheduling of one or more remaining sessions of the education course). System 300 is also similarly configurable for causing at least one of a user's progress during one coaching session 541 and a succeeding ordinary evaluating 531 to modify otherwise presented coaching 542 content or coaching content scheduling.

Such modifying of one or more prior education sessions of one or more later education session of the same or a different type might further, for example, result where a user does not complete a prior session, evaluating determines that some repetition or supplementing is appropriate to the user's needs or goals, a prior (evaluating) session indicates that prompting of some level should be presented or presented in a different form or media where it might not otherwise be so presented, among other examples.

FIGS. 6A1-6A4 illustrate an exemplary menu structure that may comprise all or part of a user interface portion of an education interface embedded by system 300 (FIG. 3A) within an activity system. It will be appreciated that the same or different user/learning interfaces or user/learning interface portions may further be similarly embedded within other activity systems or a globally applicable such interface may be provided within or external to a particular activity system (e.g., as a so-called floating menu, launching pad, and so on) or OS, or some combination, in accordance with the requirements of a particular implementation. (It may, for example, be desirable to provide a single or limited user/learning interface in conjunction with a host device having limited processing or storage resources, among other considerations.) It will further be appreciated that the user interface may include one or more of graphical, audio, speech recognition/synthesis or other media, biometrics, sensory or other actuation/feedback, among other permutations.

FIG. 6A1 illustrates an activity system 600 having an exemplary graphical user interface (“GUI”) 601, such as with a local or mobile code running on a PC, PDA, settop box, and so on. GUI 601 further includes an exemplary embedded education menu 502 comprising menu items including learning type 621, activity detail 622, plan/schedule sessions 623, level of detail 624 and preferences 625, and may include one or more education buttons for invoking these or other integrated education system features. (Note that the options provided are not intended to be limiting and the particular options provided may vary substantially in accordance with the requirements of a particular implementation.)

Learning type 621 and activity detail 622 illustrate two exemplary approaches to causing providing of education to be initiated in an integrated manner with one or more corresponding (actual or faux) selected activities of an activity system (e.g., 611), at least one of which is preferably provided. (We assume for purposes of the present example that one or more corresponding activities is selected.)

User selecting of learning type 621 provides a more direct selecting of user learning in which the user selects a learning type indicator indicating an learning topic or goal to be provided corresponding to an indicated ordinary activity, or further, to similar activities (A corresponding ordinary activity may be selectable prior to or following education type or other learning-related selecting). In this example, selecting learning type 521 causes presenting of a further learning type window.

Learning type (or “topic”) window 603 of FIG. 6A2, for example, enables a user to associate and thereby initiate a user-selectable education type in conjunction with selecting of an activity system activity. (It will be appreciated that, as with other user interface components, presenting one or more of selection (sub) menus, windows (or pop-ups), other interface components, other applications or other local/mobile program code can also be initiated instead or in conjunction with menu components for enabling user interaction. As was noted, such types, content or other information may also be locally or remotely located and initiated, for example, by an API or loader.)

Particular learning topics may vary considerably in accordance with a particular implementation and may, for example, include but are not limited to one or more of those indicated in the following Chart 1. System 300 (FIG. 3A) responds to user selection (e.g., via APIs 321) by providing a selection window, such as window 604 of FIG. 6A2, enabling a user to identify and select a desired learning type from a database of learning content of associated types. Such identifying may, for example, include a user-entering a search term (e.g., 641-643), initiating browsing of available learning types (e.g., 644) or sorting a resulting list or other presentation of learning types (e.g., 645-646), and so on, from which the user may select a desired learning type. Note that the sample learning topics cover a representative but not comprehensive list of possible learning that may be included in a variety of learning types or scenarios that may further utilize coaching, prompting, evaluating or other learning activities/events. Learning scenarios may further include but are not limited to one or more of courses, tutorials, labs, modules, sessions, training, reviews, and so on.

TABLE 1
Learning Topic Examples

| Topic | Description |
|---|---|
| Performance Coaching | Coaching Employee Performance |
| Budgeting for Beginners | Evaluating and Creating Budgets |
| Solution Selling | Beyond Products: the New |
| | Customer Focus |
| Network Security 200 | Advanced Network Security |
| Marketing 101 | The Basics of Marketing |
| Better Golf | Elements of Golf Mechanics |
| Wagnerian Opera | Listening to Wagner for |
| | the Opera Fan |
| Wine-tasting Basics 3 | Conducting a Wine-tasting |
| | Session |

Activity detail 622 (FIG. 6A3) provides an example of an indirect mechanism for determining user learning in which system 300 (FIG. 3A) responds to a user selecting of an ordinary activity indicator by determining a learning type. In this example, user selecting of activity detail 622 also causes presenting of a preferably similarly operable selector (e.g., selection window) as with learning type 621 of FIG. 6A2. However, the section window enables a user to enter or search for indicators that are instead descriptive of or otherwise provide for specifying a corresponding ordinary activity. In such a manner, system 300 provides for responding to specifying of ordinary activity information (e.g., by a user or activity system) by providing a user with corresponding learning.

System 300 responds to the user selecting by associating the activity indicator with a corresponding learning type. Also as with learning types, particular activity details can vary considerably in accordance with a particular implementation and may, for example, include but are not limited to learning topics having differing levels, time periods, content, evaluation or other constraints, user goals, corresponding user devices, and so on.

Plan/schedule sessions 623 (FIG. 6A4) provides an example of how system 300 enables a user to directly impact an education session schedule via an integrated learning system. As was discussed earlier, operating an integrated learning system in conjunction with an activity system that provides for scheduling enables activity system based user entry or modification of corresponding education sessions or activities. However, many such scheduling capable systems do not provide such capabilities.

Plan 623a, for example, enables a user to initiate the aforementioned education session planning, which plan is provided by system 300 and may preferably be accepted, cancelled or modified by a user. Schedule 623b enables a user to initiate scheduling or re-scheduling of one or more education sessions corresponding to one or more education courses including more than one education session. Session scheduling may, for example, be modified according to due date or by modifying minimum/maximum time between sessions, time/activities during which sessions should or should not be conducted or other parameters according to which scheduler 346 (FIG. 3A) may calculate session scheduling. Cancel 623c enables a user to cancel an education session/course, while move/modify 623d enables a user to initiate a delay, move forward or perform some other modification of one or more education session/course.

Level of detail (FIG. 6A5) provides an example of how system 300 enables a user to select from among different levels of one or more education activities/sessions or activity/session types, and thereby further customize education sessions to his needs. Four examples are depicted as indicators of the various levels of learning that might be provided, including simple overview 624a, detailed overview 624b, overview with links to further details 624c and a more complete course work level 624d. However, various options affecting learning to be provided on a globally applicable basis, for each education course/session (e.g., evaluating, coaching, prompting, and so on) or for particular actitivities/sessions may also be provided at one or more levels in accordance with the requirements of a particular application.

Preferences 625 (FIG. 6A6) provides a further example of how system 300 enables contouring of learning to a user's needs. Selecting 625a, for example, provides for user selecting of default learning levels or other education content related parameters. Scheduling 625b provides for user selecting of typically default scheduling options, such as attempting to schedule an evaluating or coaching type session during particular days or portions of the day, preceding or following a corresponding or non-corresponding activity by a predetermined amount of time, scheduling sessions a predetermined number of days apart or between or among some minimum/maximum, scheduling evaluation type sessions before or after another session type, and so on. Presentation 625c provides for user selecting of media or other parameters for presenting of education content (including any user responses).

Of the remaining user interface elements, online access 625d provides for user entry/selecting of preferences, security, identifiers, communication or other information for facilitating online access to ordinary activity or learning information. Activities/Programs 625e provides for user selecting of program code supported by learning system portions (e.g., APIs 321) for which corresponding learning might be provided or through which learning system portions might provide for scheduling or presentation (e.g., providing scheduling through Outlook, some other program or more than one program for all or some activities, or providing for presentation via one or more particular predetermined programs).

FIG. 6B illustrates a further example of a learning integration system user interface showing education session scheduling in conjunction with a corresponding ordinary activity. More specifically, system 300 (FIG. 3A) provides for one or more of presentationally and programmatically embedding education activity/session scheduling indicators within an activity system. Presentational embedding enables indicators to appear to a user as though they are included within a host interface, while programmatic embedding actually adds or otherwise integrates links or other underlying information within the host enabling data exchange or other inter-operation (e.g., see above).

In this example, system 300 (FIG. 3A) provides for presentationally integrating education session scheduling information including session due dates within activity data placeholders provided by the activity system for scheduling of ordinary activities (appointments, todo items, project portions, and so on) whether or not such placeholders include scheduled activities. Such embedding may, for example, be implemented by inserting or further linking a textural, graphic or other representation of the education session scheduling information to presentation information representations provided by the activity system (e.g., effectively attaching iconic or textural session information such as 661b, 661c to placeholders 661a of an activity system scheduling feature, such as with so-called “sticky notes”). Such embedding may also be implemented by so called “floating” of the scheduling information above the presentation information (e.g., in an invisible interface window, among other otherwise conventional mechanisms for attaching program information of business programs). More preferably, more modern mechanisms such as object linking or other programmatic embedding in conjunction with systems that provide for such linking or embedding or some combination may be used.

System 300 (FIG. 3A) further preferably further provides for programmatically embedding session scheduling information using one or more of writing to activity system memory, providing a data link (e.g., using so-called dynamic data exchange or “DDE,” and so on) or any other suitable mechanism. In this manner, session schedule information may be viewed, modified or initiated in a similar manner as with the ordinary activity information. Thus, for example, moving or deleting learning icon 661c in an otherwise conventional manner (e.g., dragging or via menu selection) may cause not only a re-positioning of the text, icon or other representation, but also a re-scheduling of the underlying education session due date (by one or more of operation of the activity system or learning system responding to activity events with education system generated scheduling information. Similarly, invoking the representation may enable conventional editing of the underlying information, or further conducting of the underlying education session.

Continuing now with FIGS. 7A and 7B, two examples of education session scheduling are illustrated. In the FIG. 7A placeholder example, a user selects an activity system placeholder and then selects an option such as learning type 521 or activity detail 522 of FIG. 5A1. System 300 responds by conducting education course/session scheduling or initiation in accordance with scheduling parameters that may further be integrated into a learning model (e.g., enabling activity/session-level control of scheduling by a course creator), or be otherwise implemented by separate system 300 scheduling.

In the FIG. 7B example, system 300 (FIG. 3A) responds to a user selects a learning system option, such as learning type 521 or activity detail of FIG. 5A1, by presenting to the user a palate of coaching session indicators indicating a corresponding education course (e.g., via one or more of the above presentational embedding mechanisms), which indicators the user places in conjunction with desired ordinary activities, ordinary activity groupings, due dates, and so on. As already discussed, system 300 may optionally respond by analyzing the user choices, conduct scheduling of any remaining education activities/sessions (e.g., evaluating, prompting, and so on) and embed the remaining sessions within the activity system. (Other options, that might further include the above examples, will also become apparent to those skilled in the art.)

FIGS. 8A through 8B further illustrate examples of learning information storage configurations that may be utilized in conjunction with one or more of teaching engines storing or presenting of education information. In FIGS. 8A and 8B, storage configurations 800 and 800a exemplify learning information stored in one or more of evaluation information storage 361, coaching information storage 362, prompting information storage 363 and scheduling information storage 364 of FIG. 3A.

Beginning with FIG. 8A, system 300 (FIG. 3A) is configurable for presenting education content to a user corresponding to a topic that is directly or indirectly selected by a user in conjunction with an activity system activity. System 300 is configurable for associating one or more education topics 801 with one or more corresponding education activities/sessions 802, 803. The present example illustrates a total of A topics 811-813, B education sessions 811-813 associated with topic-1 811, C education sessions 831-833 associated, and so on. Thus, configuration 800 enables system 300 presenting, to a user who has selected a topic, complete education content for each session that is associated with the selected topic (according to an education session schedule). Configuration 800 further enables system 300 to similarly provide for scheduling of such presenting.

Configuration 800a of FIG. 8B further provides for implementing one or more of the above-discussed education levels or of interactively or completely presenting an education activity/session in accordance with the requirements of a particular application. For clarity sake, configuration 800a also includes one or more topics 811a-813a and one or more education sessions 831-833. Configuration 800a also includes one or more education levels (e.g., 804, 804a) and one or more education session presentations (e.g. 805, 805a). (As was discussed above, education presentations include education activity/session portions that may be separately (e.g., interactively) provided to a user as portions of a same activity/session or as alternatives that are selectable in accordance with one or more of prior activity/session results, scheduling requirements, prior presentations, and so on.)

In this example, system 300 (FIG. 3A) is configurable for associating one or more of education topics 801a with one or more education levels or education session presentations, or of associating one or more education levels with one or more education session presentations. Thus, for example, the present configuration 800a associates education topic-1 811a with education levels 804, education level-1 841 with education sessions 802, education session-1 821 with education session presentations 805, and so on. System 300 is also configurable, for example, where education levels are disabled or otherwise not used, for associating learning topics with corresponding education activities/sessions, as indicated by dashed lines. Configuration 800a further enables system 300 to similarly provide for scheduling of such presenting.

Configuration 800a enables system 300 to provide a user with education session scheduling that may, for example, provide for fitting one or more of more easily digestible (“lower level”) sessions that are better suited to being more quickly presented, fewer sessions, supplementary, repeat or advanced sessions (e.g., as in 374a-c of FIG. 3B), and so on, or the converse, in accordance with an activity due date, user selection, evaluation, or other requirements of a particular application. Configuration 800a also similarly enables user or learning system selecting of content having a higher or lower level, different media, greater relevance to a user (e.g., determined by the learning system from user preferences, ordinary activity content, prior ordinary activity/learning content, and so on).

FIG. 9 further illustrates examples of system 300 presenting of complete or interactively provided education sessions in conjunction with exemplary education session content. (For clarity sake, we will again presume the foregoing example of a user associating education sessions with a corresponding end-of-year review meeting activity in conjunction with a calendaring activity system. However, an exemplary education topic includes “Conducting an end of year review”, and education sessions which are scheduled with due dates having different and non-overlapping start times on the same day.) The education sessions are shown as corresponding with session indicators 911c through 913c and a portion of the corresponding education content is shown respectively as learning information 902 through 904.

Operationally, system 300 (FIG. 3A) responds to education activity events that are generated by a user selecting an activity indicator or interface option (e.g., learning menu item) or by operation of activity system 901. System 300 responds in conjunction with the coaching session scheduled with a due date of a current day (not shown) at 11:30 am by presenting at least learning information 902. As illustrated by dotted lines, learning information 902 may be completely presented in conjunction with a learning system complete presenting configuration (e.g., see FIG. 8A) including the education content shown or further education content. (Note, however, that the illustrated content is merely exemplary.) Alternatively, education information 902 may include an education activity/session presentation that might further represent an associated education level, such that education information 902 and 902a may be presented completely or by system 300 interactively presenting successive education session presentations. System 300 similarly responds to education activity events by completely or interactively presenting education content 903 (or further, 903a) in conjunction with end of year review 912a, and by completely or interactively presenting education content 904 (or further, 904a), which has a due date of the current day at 3:00 pm.

It will be appreciated that, while the exemplary coaching content 902 includes only a textural lesson, such information may also similarly include other media or provide for user responses, including but not limited to the questionnaire type content of evaluating content 904. Prompting content 903, while typically non-responsive by a user, may further include other media or a response portion, as may evaluating content 904. For example, a user conducting a meeting may select presenting of graphic, audio, video or other multimedia content, a summary versus detailed prompting, or prompting may provide for user notes, annotations, and so on, in accordance with education activity/session parameters, user objectives or other aspects of a particular application.

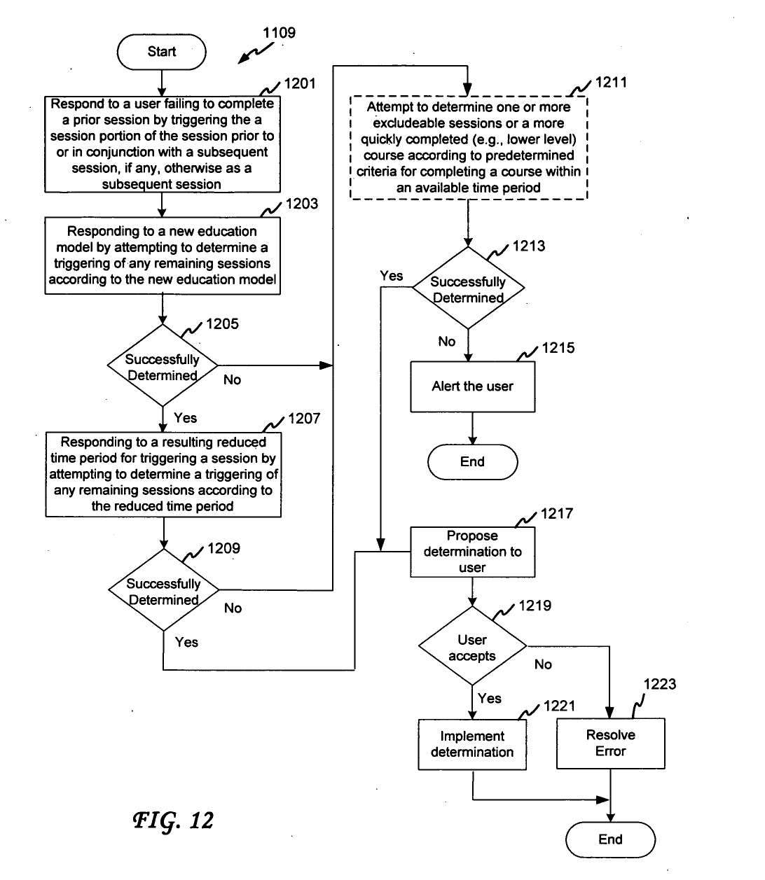

Turning now to the FIG. 10 flowchart, an education integration method embodiment 1000 is illustrated in which, in step 1001, the education system provides for integrating an education system interface with an activity system. In step 1003, the education system receives, via the education interface, one or more ordinary activity indicators indicating one or more corresponding activity system activities. As discussed above, such activities are typically planned activities, but may also include a selected activity that has been entered or otherwise initiated without scheduling.

In step 1005, the education system receives one or more education type indicators indicating a learning type. As discussed, the type indicators may indicate an education topic, an activity detail or other descriptor, a user goal, and so on, in accordance with a particular application. (Conversion from other than an education topic can be conducted, as needed, by the activity system, an OS, converter or other intermediary system, or the education system, for example, as was already discussed.) The type indicators can also include one or more of an education level or other education parameter(s) in accordance with the requirements of a particular application.

In step 1007, the education system determines an education course including one or more education activities/sessions corresponding to the education type. The education course may, for example, be determined in accordance with one or more of a learning model, user preferences relating to scheduling, content, media, devices, and so on (e.g., see above).

In step 1009, the activity system, learning system or both provide for triggering conducting of one or more of the education activities/sessions, preferably in a coordinated manner with at least one corresponding ordinary activity. Typically, such triggering includes the learning system determining scheduling of the education activities/sessions according to the education model, user preferences or other parameters. However, a given implementation may also provide for selecting or modifying activity/session scheduling by one or more of a user via the learning interface or an activity system interface (e.g., see FIGS. 6a1-7b), user conducting of one or more education activities/sessions (e.g., see FIG. 12), and so on, in accordance with a particular implementation.

In steps 1011 and 1013, the education activity/session is conducted according to the schedule or other trigger. (As shown, however, a user may cancel or otherwise not conduct one or more education sessions, activities or portions thereof, and either or both may further never be initiated or be initiated or conducted other than in accordance with a schedule or other trigger.)

The FIG. 11 flowchart further illustrates an example of the determining step 1007 of FIG. 10 in greater detail. As was discussed above, an education course may include one or more sessions. The sessions may further include one or more session/activity types, such as evaluating, coaching, prompting, meta evaluating, various levels of activities/sessions or other activity/session types as might be used according to the requirements of a particular learning model, user device/network resources or other requirements of a particular application. The present integrated education example, however, provides for at least one each of evaluating (step 1101), coaching (step 1103 and prompting (step 1105).

The method 1107 example further provides for scheduling of such activities/sessions, and at particular times or upon particular events. More specifically, the at least one evaluating activity/session is preferably scheduled to be conducted at least one of prior to and following planned conducting of a corresponding ordinary activity, the at least one coaching activity/session is preferably scheduled to be conducted prior to a corresponding ordinary activity, and the at least one prompting activity/session is preferably scheduled to be conducted concurrently with a corresponding ordinary activity.

Steps 1107 and 1109 further provide for conducting modifying of education activity/session triggering (here, scheduling) corresponding to receiving of an activity or education session schedule modification (e.g., by the education system from the activity system).

FIG. 12 illustrates a further example of conducting the modifying of step 1109 of FIG. 11. Step 1201 of FIG. 12 provides for responding to a user failing to complete a prior session (e.g., by the education system) by scheduling or otherwise triggering a portion of the incomplete session (e.g., the portion not completed, the whole session; from a predetermined beginning of a topic, subtopic or other starting point, and so on). Step 1201 further provides for such triggering prior to or in conjunction with a subsequent education session, if any, or otherwise (e.g., if no such session exists) as a subsequently triggered session.

Step 1203 provides for responding to a new education model by attempting to determine a triggering (e.g., scheduling) of any remaining sessions according to the new education model. For example, the new education model might require a longer time period, modification of a later session according to the results of a prior session, a particular trigger, and so on. Step 1203 thus provides for accommodating the possibility that the new model may impact the session in a way that may or may not be accommodated in accordance with completing one or more relevant sessions or a course in accordance with user preferences, conducting a corresponding activity, and so on. Further, if, in step 1205, such determining cannot be made according to such predetermined criteria, then the method continues with step 1211.

Step 1207 still provides for responding to a resulting reduced time period for triggering a session for other reasons than the use of a new learning model by similarly attempting to reschedule or otherwise trigger as in step 1205, and also proceeds with step 1211 if such trigger cannot be successfully determined (e.g., by the education system).

Step 1211 provides for attempting to determine one or more education sessions that (according to predetermined criteria) might be excluded or for selecting a course type or level that might be completed within a desired time period or before a particular event (e.g., a due date of a corresponding activity in which having such education is desirable).

If in step 1213 such determining successfully meets the predetermined criteria, then in step 1217 the determination (e.g., new education session scheduling) is presented to a user. If the user accepts the determination in step 1219, then the determination is implemented (e.g., a schedule modification corresponding to the determination is implemented). If instead in step 1219 the user does not accept the determination, then an error condition exists that is resolved in step 1223 in accordance with a particular application.

If instead in step 1213 a successful determination cannot be found, then the education system causes the user to be alerted in step 1215 (e.g., directly, via an activity system, via a further program, and so on).

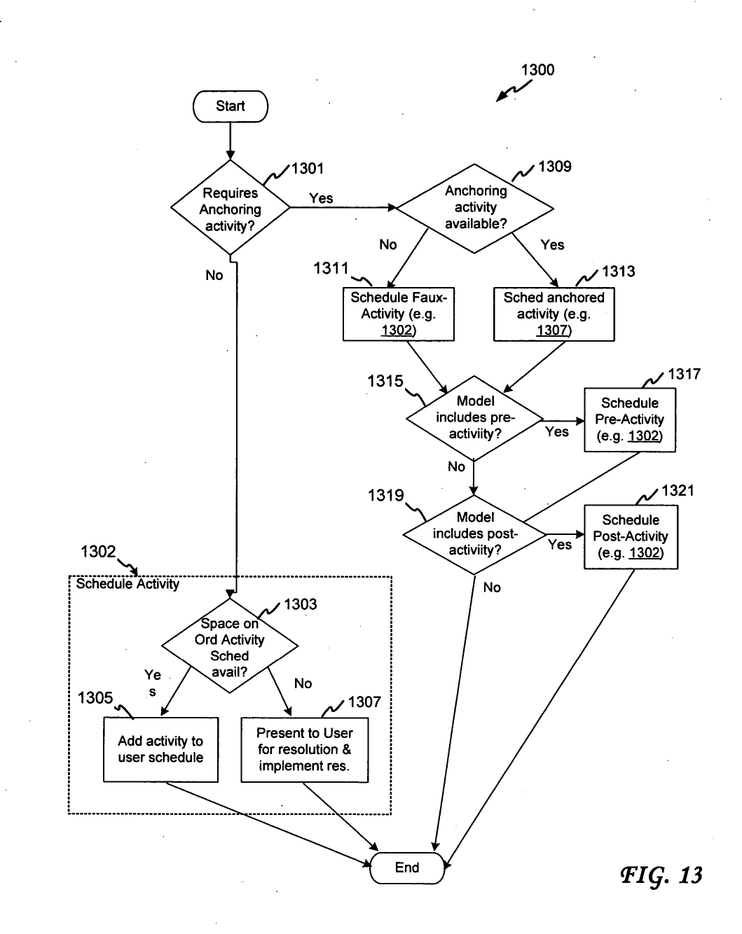

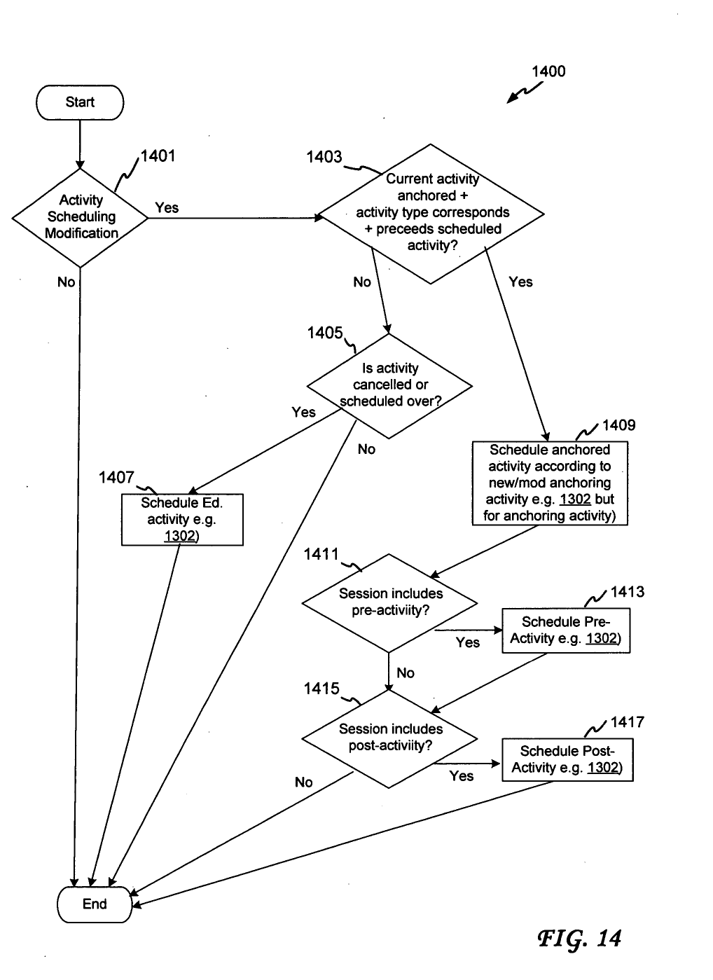

The FIG. 13 flowchart, with reference to FIGS. 3A and 3B, illustrates a method for scheduling one or more education sessions forming all or part of a course that includes at least one anchored session, according to an embodiment of the invention. While directed at an optimistic approach integrated within an education model via education model parameters, method 1300 also provides for scheduling of non-integrated scheduling or deterministic approaches including but not limited the exemplary method 1500 of FIG. 15. The method is further preferably implemented by an integrated education system.

As shown in FIG. 13, in step 1301, the education system receiving learning parameters of a current education activity/session (i.e., to be scheduled or executed), determines whether the current activity/session utilizes or further requires an anchoring (e.g., ordinary/faux) activity. If, in step 1301, an anchoring activity is required, then the method proceeds with step 1309; otherwise the education system schedules the activity in step 1302.

Scheduling step 1302 preferably includes integrating the activity/session scheduling with an ordinary activity schedule, for example, as discussed above. Activity scheduling step 1302 includes determining whether space is available on an ordinary activity schedule in step 1303 (e.g., the user ordinary activity schedule is not too full, the user is not on vacation, the available due date(s) are suitable or scheduling is not otherwise inhibited according to scheduling parameters of the activity or education system). If, space is available in step 1303, then the education system adds the activity to the schedule in step 1305; otherwise, the education system presents the scheduling inability to the user for resolution and implements the user resolution in step 1307. (It will be appreciated that an education system may also attempt to automatically resolve scheduling problems and seek user intervention if automatic resolution is unsuccessful.)

In step 1309, the learning system determines whether a suitable anchoring activity is available. As discussed, the learning system may, for example, receive from or poll one or more user activity systems for scheduling information corresponding to scheduled activities and compare the activity type and scheduling with minimum/maximum, presentation period or other education session scheduling parameters (e.g., of an education model). If, in step 1309, no suitable anchoring activity is available, then the education system schedules a faux activity corresponding to the current education session in step 1311 (e.g., according to activity scheduling step 1302). If instead, in step 1309, a suitable anchoring activity is available, then the education system schedules the current session anchored activity in step 1313. (It will be appreciated that the determination of the existence of a suitable anchoring activity in step 1309 typically obviates the need to conduct scheduling 1302 steps 1303 and 1305, and the anchored activity may be added to the activity schedule, for example, as given by step 1307.)

In step 1315, the learning system determines whether the current session includes one or more pre-activities. If so, then the learning system schedules the pre-activity (or activities) in step 1317; otherwise, the learning system proceeds with step 1319. (As discussed, pre-activities typically do not utilize an anchoring activity and may be scheduled prior to an anchored or faux activity according to session scheduling parameters.)

In step 1319, the education system determines whether the current session includes one or more post-activities. If so, then the learning system schedules the post activity (or activities) in step 1321. (As discussed, post activities typically do not utilize an anchoring activity and may be scheduled following an anchored or faux activity according to predetermined or user modifiable session scheduling parameters.)

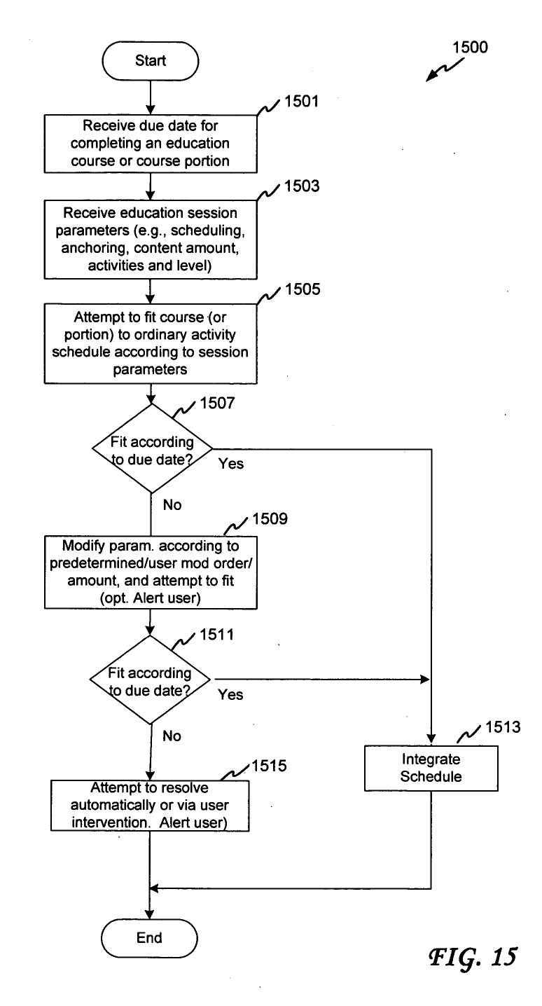

The FIG. 14 flowchart, with reference to FIGS. 3A and 3B, illustrates a method for modifying of scheduling one or more education activities/sessions forming all or part of a course that includes at least one anchored activity, for example, in response to a user modification of an ordinary activity, according to an embodiment of the invention. As with method 1300 of FIG. 13, method 1400 is directed at an optimistic approach integrated within an education model via education model parameters. However, method 1300 also provides for scheduling of non-integrated scheduling or deterministic approaches that also utilize one or more anchored activities. The method is further preferably implemented by a learning integration system.

As shown in FIG. 14, the method proceeds if the learning system receives an indicator indicating a user or other ordinary activity scheduling modification in step 1401.

In step 1403, the learning system determines whether the modification corresponds to a current anchored activity of a corresponding type and if the modified ordinary activity precedes scheduling of the education activity. If so, then the learning system (re)schedules the anchored activity according to the modified anchoring activity, if the modified anchoring activity meets with session anchored activity scheduling parameters, or if not, determines and schedules the anchored activity according to a new anchoring activity. As illustrated, the re-scheduling may, for example, be conducted in accordance with step 1302 of FIG. 13, but with respect to a suitable available anchoring activity. Steps 1411 through 1417 provide for further scheduling of any pre or post session activities that may be associated with the anchored activity re-scheduled in step 1409. In step 1411, the education system determines whether the current session includes a pre-activity, and if so, schedules the pre-activity in step 1413 (e.g., according to step 1302 of FIG. 13). In step 1415, the learning system determines whether the current session includes a post-activity, and if so, schedules the post-activity in step 1413 (e.g., according to step 1302 of FIG. 13). (Steps 1409 through 1417 can also be accomplished according to steps 1309 through 1321 of FIG. 13.)

If instead, in step 1403, the learning system determines that one or more of the requisite conditions are not met, then method 1400 proceeds with step 1405. In step 1405, the learning system determines whether the corresponding ordinary activity is cancelled or replaced (scheduled over). If not then the method ends. Otherwise, in step 1407, the learning system schedules the current education activity (e.g., according to step 1302 of FIG. 13).

The FIG. 15 flowchart, with reference to FIGS. 3A and 3B, illustrates a method for providing integrated learning employing a deterministic model, according to an embodiment of the present invention. In step 1501, a learning system receives, from an activity system, a due date for completing an education course or course portion. As discussed above, the due date more preferably includes a due date of an ordinary activity defined automatically or by a user as a type corresponding to at least one education course or session. The ordinary activity may further correspond to an anchoring activity. In step 1503, the learning system receives education session parameters of at least one corresponding education session. The session parameters may, for example, include one or more of scheduling parameters, anchoring parameters, content type, content amount, associated activities (e.g., complex or integrated activities, level(s) and so on.

In step 1505, the learning system attempts to fit executing of the course (according to an education schedule plan) within an ordinary activity schedule such that the course is completed by the due date. If, in step 1507, the learning system successfully calculates a suitable education schedule, then the education system integrates the education schedule into the ordinary activity schedule in step 1513. Otherwise, method 1500 continues with step 1509.

In step 1509, the learning system modifies the session parameters (e.g., using a recursive calculation) in accordance with a predetermined or user-modifiable modification order/amount, recursively attempting to fit course sessions within the ordinary activity schedule. The learning system further optionally notifies a user of the failed attempt of step 1507 and the attempted modification. If, in step 1511, the learning system determines an education schedule that may be completed by the due date, then the learning system integrates the education schedule into the ordinary activity schedule in step 1513. Otherwise, the learning system notifies the user of the failed attempt of step 1511 and receives and implements a user resolution which may include integrating a resulting education schedule into the ordinary activity schedule in step 1515.

The foregoing description of preferred embodiments of the invention is provided by way of example to enable a person skilled in the art to make and use the invention, and in the context of particular applications and requirements thereof. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein. The embodiments described herein are not intended to be exhaustive or limiting.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general purpose digital computer, application specific integrated circuits, programmable logic devices, field programmable gate arrays, a network of interconnected components and circuits, and so on, or some combination thereof. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A learning integration system, comprising:
an ordinary activity system (activity system) for processing one or more ordinary activities of a user;
an education integrator coupled to the activity system for determining ordinary activity processing of one or more ordinary activities by the activity system; and
an education manager coupled to the education integrator for determining one or more learning activities corresponding to one or more of the determined ordinary activities to present to the user.

2. A learning integration system according to claim 1, wherein the activity system is selected from a group including scheduling, todo, conferencing, communication, project management and contact management systems.

3. A learning integration system according to claim 1, wherein the processing one or more ordinary activities includes one or more of storing, selecting, scheduling, documenting and initiating.

4. A learning integration system according to claim 1, wherein the education integrator comprises an application program interface (API).

5. A learning integration system according to claim 1, wherein the education integrator includes a learning activity associator for associating at least one of the determined learning activities with the one or more ordinary activities.

6. A learning integration system according to claim 1, wherein the education integrator includes a type selector for selecting an activity type corresponding to at least one of the learning activities according to which the education manager determines the one or more learning activities.

7. A learning integration system according to claim 1, wherein the education integrator includes a faux activity creator for creating a faux activity within the activity system if the determined ordinary activity processing indicates an absence of an ordinary activity to which at least one of the learning activities may correspond.

8. A learning integration system according to claim 1, wherein the education manager further comprises a learning model

9. A learning integration system according to claim 8, wherein the model comprises education scheduling parameters for scheduling presenting of learning content of the learning activities to the user.

10. A learning integration system according to claim 1, wherein the education manager further comprises a coacher, a prompter and an evaluator.

11. A learning integration system according to claim 10, wherein the coacher comprises means for presenting learning content prior to at least one of an ordinary activity and a faux activity.

12. A learning integration system according to claim 10, wherein the prompter comprises means for presenting learning content during at least one of an ordinary activity and a faux activity.

13. A learning integration system according to claim 10, wherein the education scheduling parameters include a minimum time period following presenting of a preceding education activity corresponding to one or more of the education activities and a maximum time period following presenting of a preceding education activity corresponding to one or more of the education activities.

14. A learning integration system according to claim 1, wherein the learning activities comprise one or more of anchored learning activities and non-anchored learning activities.

15. A learning integration system according to claim 1, wherein the learning activities comprise one or more of coaching, prompting, user preparedness evaluating and user ordinary activity performance evaluating.

16. A learning integration method, comprising:
determining processing of one or more ordinary activities by an activity system;
determining at least one learning activity corresponding to at least one of the ordinary activities; and
scheduling presenting of the at least one learning activity at a due date corresponding to a due date of at least one of the ordinary activities.

17. A learning method according to claim 16, wherein the determining processing of one or more ordinary activities comprises implementing a learning application program interface (API) corresponding to the activity system for receiving activity events corresponding to activity system processing of the ordinary activities via the API.

18. A learning method according to claim 16, wherein the API is further operable to insert learning activities into data of the activity system, such that the learning activities are modifiable via user operation of a user interface of the activity system.

19. A method according to claim 16, wherein the determining at least one learning activity comprises:
determining at least one of an activity type and a user goal corresponding to at least one of the ordinary activities; and
determining at least one learning activity corresponding to the activity type.

20. A method according to claim 16, wherein the determining at least one learning activity comprises:
determining at least one of an activity type and a user goal corresponding to at least one of the ordinary activities; and
determining at least one learning session including the at least one learning activity.

21. A method according to claim 16, wherein:
the determining at least one learning activity comprises determining a learning course including learning activities, at least one of the learning activities corresponding to at least one of the ordinary activities; and
the scheduling presenting of the at least one learning activity comprises attempting to schedule the learning course for completion on or before the due date, and if the attempting fails, further substituting at least one lower level activity for at least one of the learning activities and attempting to schedule the course with the substitution for completion on or before the due date.

22. A computer-readable storage medium storing program code for causing a data processing system to perform the steps of:
determining processing of one or more ordinary activities by an activity system;
determining at least one learning activity corresponding to at least one of the ordinary activities; and
scheduling presenting of the at least one learning activity at a due date corresponding to a due date of at least one of the ordinary activities.

23. A learning integration method, comprising:
determining a presentation period of a learning activity;
determining whether the learning activity is an anchored learning activity, and if so:
a) determining whether an ordinary activity of an activity system that includes a due date corresponding to the presentation period (learning opportunity) exists within an ordinary activity system; and
b) scheduling presenting of the learning activity to correspond with the due date if the learning opportunity exists.

24. A learning integration method according to claim 23, further comprising, if the learning opportunity does not exist:
adding a faux ordinary activity (faux activity);
scheduling a due date of the faux activity within the presentation period; and
scheduling presenting of the learning activity to correspond with the due date of the faux activity.

25. A learning integration method according to claim 23, wherein the determining whether the learning opportunity exists further includes determining that a learning opportunity does not exist unless an ordinary activity having a due date corresponding to the presentation period also corresponds to a learning activity type of the learning activity.

26. A learning integration method according to claim 25, wherein the determining whether the learning opportunity exists includes receiving from a user an ordinary activity type selection corresponding to an ordinary activity.

27. A learning integration method according to claim 23, further comprising:
determining whether the learning opportunity is a part of a learning session including one or more other learning activities, and if so:
scheduling presentation of the other learning activities at a due date corresponding to the scheduled presenting of the learning activity.

28. A learning integration method according to claim 27, wherein the scheduling presentation of the other learning activities comprises:
determining a presentation period of the other learning activities corresponding to the learning activity;
determining whether any of the other learning activities are anchored activities, and if not, then for at least one of the other learning activities:
a) determining a due date during the presentation period of the other learning activity during which no ordinary activities are being conducted (available due date); and
b) scheduling presenting of the other learning activity during the available due date.

29. A learning integration method according to claim 28, wherein the learning activity and the other learning activities comprise a learning session within a learning course.

30. A learning integration method according to claim 23, wherein the learning activity is selected from a group including coaching learning activities, prompting learning activities and evaluation learning activities.

31. A computer-readable storage medium storing program code for causing a data processing system to perform the steps of:
determining a presentation period of a learning activity;
determining whether the learning activity is an anchored learning activity, and if so:
a) determining whether an ordinary activity of an activity system that includes a due date corresponding to the presentation period (learning opportunity) exists within an ordinary activity system; and
b) scheduling presenting of the learning activity to correspond with the due date if the learning opportunity exists.
